(19) United States
(12) Patent Application Publication
(10) Pub. No.: US 2026/0072961 A1
(43) Pub. Date: Mar. 12, 2026

(54) CONTENT SEARCH SYSTEM

(71) Applicant: Benjamin Firooz Ghassabian, Toulon (FR)

(72) Inventor: Benjamin Firooz Ghassabian, Toulon (FR)

(21) Appl. No.: 19/211,335

(22) Filed: May 19, 2025

Related U.S. Application Data
(60) Provisional application No. 63/652,061, filed on May 27, 2024.
(60) Provisional application No. 63/701,173, filed on Sep. 30, 2024.
(60) Provisional application No. 63/709,422, filed on Oct. 19, 2024.

(51) Int. Cl. G06F 16/334; G06F 3/023; G06F 3/0489; G06F 16/338

(52) U.S. Cl. CPC G06F 16/334; G06F 3/0237; G06F 3/04897; G06F 16/338

(57) ABSTRACT

A system for searching a user's desired content within a database of textual contents is described. The contents may be of any kind such as movie titles, music titles, song titles, scientific terms, medical titles/terms, titles formed of one or more sequences of symbols, a list of telephone numbers, a contact list, web pages, etc. Upon providing one or more keyword by interacting with a keyboard adapted to the search system, the search system selects one or more corresponding textual contents from the database. According to one aspect, the system further considers the location relationship of user's consecutive interaction impacts on the keyboard to define the order of the selected textual contents to be presented to the user.

### FIELD OF THE INVENTION

The present invention relates to a simplified search system for searching textual contents within a database and/or a (e.g., one or more) corpus of textual contents. A textual content may be/include contents of any kind such as a word, a number, a phrase, a paragraph, a text (e.g., an article), etc. A textual content may include one or more characters such as: letters, digits, punctuation characters, images/symbols (e.g. emoticons), etc.

For simplicity and clarity of illustration, reference numerals may be repeated among the figures to indicate corresponding or analogous elements. Also, similarly named elements perform similar functions and are similarly designed, unless specified otherwise. Numerous details are set forth to provide an understanding of the embodiments described herein. The embodiments may be practiced without these details. In other instances, well-known methods, procedures, and components have not been described in detail to avoid obscuring the example embodiments described herein. The description is not to be considered as limited to the scope of the example embodiments described herein.

Preferably, the search system of the invention uses a (e.g., one or more) database of textual contents (e.g., a textual content may herein be referred to as a “title”). A database of textual contents may be of any kind such as titles of songs, titles of videos, titles of movies, (e.g., driving) addresses, titles of (e.g., Internet/digitized) articles, (e.g., map) addresses, any other type of addresses (e.g., locations, URLs, etc.), (e.g. phone) numbers, a list/database of names, a list/database of contact names (e.g., or other information) (e.g., of a user's device/smartphone), titles/names of photos/videos, the names of text documents, a database of predefined (e.g. SMS) messages, (e.g., digitized) documents, etc. A database of textual contents/titles may also include/be comprised of a combination of different kind of textual contents such as those mentioned above. As an example, a database of textual contents/titles may include names and telephone numbers (e.g., such as a contacts database of a user's smartphone). For the reason of simplicity, a database of textual contents (e.g., phrases/titles) may herein be referred to as a database of “titles”. Also for the simplicity reason, the term “textual content” may/is herein be referred to as “title”.

Each entry of the a (e.g., one or more) textual database/s used by the system may have/be comprised of one or more words. An entry by itself may be a short or long text. Alternatively, an entry of the database may be a short text referring to a (e.g., digital) content (e.g., a song).

### BACKGROUND OF THE INVENTION

Mobile devices such as tablets, smartphone, remote controls (e.g., of TVs, etc.) smartwatches, etc., are generally small to be easy to carry and use. Use of media contents and applications running on mobile device are widely spread and have become inescapable and are part of the life of everyone. Searching for contents such as songs, movies, predefined messages, etc. is not easy on small device because of the small size of the screen. The current application is intended to disclose new simple and easy systems and methods for searching textual contents wherein either each by itself being a desired content (e.g., a predefined text message, an address, etc.) or each represents/is-related-to a desired content (e.g., a music file, a movie file, a photo, a video, etc.). A textual content may herein be referred to a “title”, a “phrase”, a message, etc.

### SUMMARY OF THE INVENTION

The search system, described in this application, provides a system that is adapted to mobile environments although it can also be used in fixed environment. The system is intuitive, accurate, fast, and easy to understand and use.

An aspect of the inventions relates to a search system that uses a keyboard having two keys to which all of the letters of a language are assigned (e.g., each of said two keys may herein be referred to as a large key and/or a zone). Preferably, the two large keys are virtual (e.g., two on-screen keys, two separate zones on a touch sensitive pad, etc.). Optionally, said two large keys are physical keys.

An aspect of the invention relates to use of the two large keys with a word prediction system/software wherein upon/during receiving a sequence of one or more interactions with the two large keys/zones (e.g. herein may be referred to a “large keys information”, “main information”, etc.), the system predicts one or more title/s from the corresponding entries of a database of titles used by the system.

Optionally, the input interface/keyboard has an alphabetical layout. Optionally, the keyboard has a traditional letter layout (e.g. QWERTY, QWERTZ, AZERTY). Optionally the keyboard has an alphabetical order. Optionally, the keyboard has a combination of virtual/soft and physical/hard keys. Optionally, (e.g. minor) modification to the layout may be provided. Preferably, the background (e.g. color, shade, etc.) of a first large zone is different than the background of a second large zone.

Preferably, special characters are divided into a plurality of groups (e.g. two groups) based on a common characteristic, each group being assigned to a different large key.

### BRIEF DESCRIPTION OF THE DRAWINGS

Exemplary non-limiting embodiments of the invention will be described with reference to the following description of embodiments in conjunction with the figures. Identical structures, elements or parts which appear in more than one figure are preferably labeled with a same or similar number in all the figures in which they appear, in which:

FIGS. 1A-1C show different keyboards of the invention having alphabetical orders/layouts wherein the letters are divided into two large zones in accordance with different exemplary embodiments of the invention;

FIGS. 2A-2F show different keyboards of the invention having QWERTY and AZERTY orders/layouts wherein the letters are divided into two large zones in accordance with different exemplary embodiments of the invention;

FIG. 3 shows a portion of an exemplary database of contents and a method of using a text predictive software and keyboard of the invention for searching contents, in accordance with different exemplary embodiments of the invention;

FIG. 4 shows an exemplary remote control device of the invention used with the searching system of the invention for searching videos on demand, in accordance with different exemplary embodiments of the invention;

FIGS. 5A-5F show exemplary remote control devices of the invention used with the searching system of the invention for searching contents, in accordance with different exemplary embodiments of the invention;

FIGS. 5G-5K show an exemplary system for searching titles, in accordance with different exemplary embodiments of the invention;

FIGS. 5L-5Z show an exemplary system for searching titles, in accordance with different exemplary embodiments of the invention;

FIG. 5Z1-5Z2 show an exemplary system for searching titles, in accordance with different exemplary embodiments of the invention;

FIG. 6 shows exemplary scenarios of search system using word completion systems by considering the beginning chars of words within titles, in accordance with different exemplary embodiments of the invention;

FIG. 6A-6B shows another exemplary scenario of search system using word completion systems by considering the beginning chars of words within titles, in accordance with different exemplary embodiments of the invention;

FIGS. 6C-6D show an exemplary system for searching titles, in accordance with different exemplary embodiments of the invention;

FIGS. 7A-7B show an exemplary keyboards of the invention implemented, respectively, within a smartphone and a steering wheel and used with the searching system of the invention for searching contents, in accordance with different exemplary embodiments of the invention;

FIG. 7C shows an exemplary keyboard of the invention having alphabetical letter arrangement for use with the search system of the invention, wherein in each keyboard the letters are divided in two groups assigned-to/constituting a large zone/key of the invention;

FIGS. 8A-8H show exemplary search system of the invention using a mixed database, in accordance with different exemplary embodiments of the invention;

FIGS. 9A-9C show an exemplary simplified keyboard of the invention used with the search system of the invention, in accordance with different exemplary embodiments of the invention;

FIGS. 10A-10F show an exemplary method for typing sloppily on a keyboard of the invention used by search system of the invention, in accordance with different exemplary embodiments of the invention;

### DETAILED DESCRIPTION OF EMBODIMENTS

The search system of the invention which its principles will be described herein uses a input interface (e.g., herein referred to as a keyboard) in which the letters of an alphabet are grouped into two groups each represented by a large key. Preferably the keyboard is a virtual keyboard such as an on-screen keyboard. Optionally the keyboard has a touch sensitive surface (e.g., a touch sensitive pad). Optionally, the keyboard is a physical keyboard with hard keys.

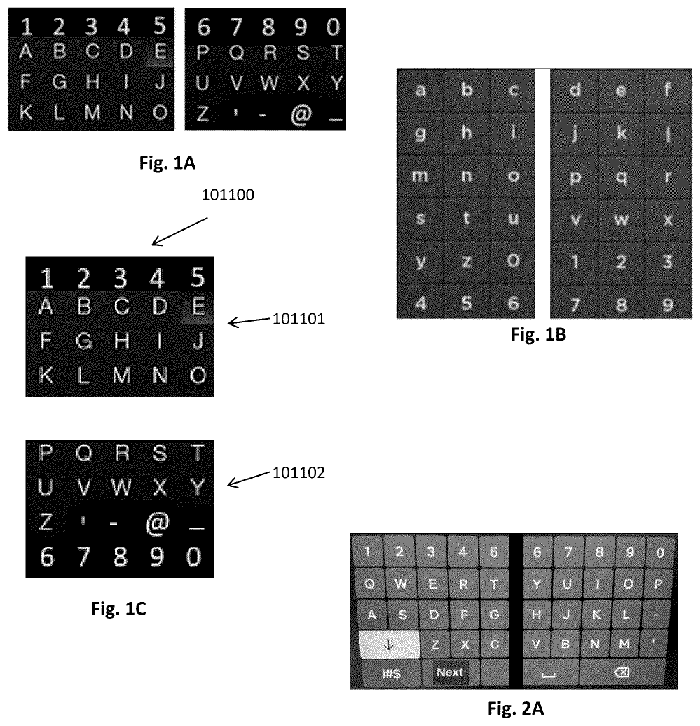

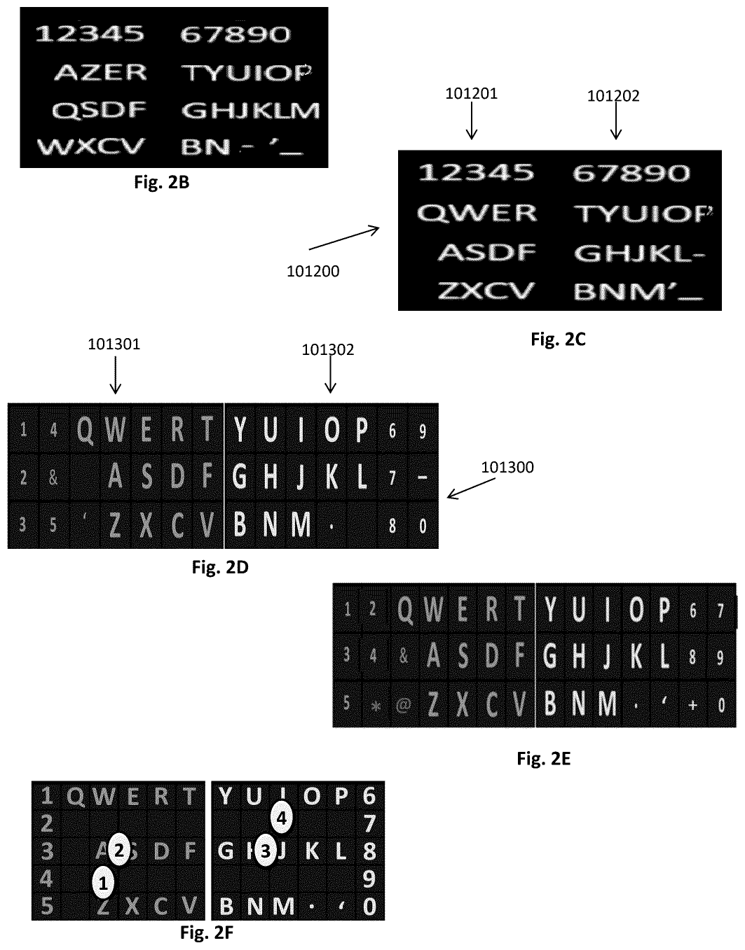

FIGS. 1A to 1C show exemplary (e.g., virtual) keyboards having different alphabetical layouts. FIGS. 2A and 2C show two exemplary QWERTY keyboards in which the letters are grouped into two groups each group represented by a large key. Note that, the letters are grouped differently in FIG. 2A than/from in FIG. 2C. FIG. 2B shows an exemplary keyboard having an AZERTY layouts in which the letters of an alphabet are grouped into two groups each represented by a large key. Optionally, a gap separates the two large keys from each other. Optionally, no gap separates the two keys from each other. In this case, preferably, the two large keys are marked in a manner (e.g., different background colors, different letter colors, etc.). It must be noted that these keyboard are shown as examples to describe the principles of the content search system of the invention. Other keyboards having different letter layout/order in which the letters of an alphabet are divided into two groups may be considered.

Optionally, a keyboard used by the search system may have a space key. Optionally, a space character me be entered by a swipe gesture on a corresponding touch and/or on the keyboard.

An interaction with a large key may ambiguously be related to interacting with any (e.g., one) of the letters assigned to said large key. An interaction with a first/left large key may produce a first input signal which herein may be represented by the digit “1” or by the letter “L”, and an interaction with a second/right large key may produce a second input signal which herein may be represented by the digit “2” or by the letter “R”. For entering a word of a title, a sequence of one or more interactions corresponding the letter/s of the word may be provided with the large keys by a user. The corresponding input signals (e.g., herein may be referred to as a “keyword”) may then be received by a processor and processed by a text predictive software using a database of titles. Based on a sequence of one or more received keyword/s (e.g., provided by a user) relating a desired title of a user, the text predictive software may present one or more corresponding titles (e.g., herein may be referred to as “search result”, “selected titles”, etc.) from a database. The user then may select a desired title from the result list.

Note that the term “large key/zone” used in this patent application does not necessarily refer-to/means the size of the/a zone/key but it rather refers to a zone/key of the keyboard to which a plurality of characters are (e.g., ambiguously) assigned. Note that the word “letter” used in this patent application may also be considered as/related to a special character as well. Accordingly, in addition to letters, a/each large zone of the keyboard may (e.g., also) include other characters such as digits, punctuation characters, images/symbols (e.g. emoticons), etc. As an example, a word of a title may be a mixture of letters, and/or special characters and/or digits (e.g., “day-7”). Accordingly, by considering the keyboard 101200 of FIG. 2C, a keyword related to said word may be “11222” (e.g., letters/characters “d” and “a” are assigned to the (e.g., left) large key 101201, and characters “y”, “−” and “7” are assigned to the (e.g., right) large key 101202 of the keyboard 101200).

Optionally, further (e.g., in addition to the large zones interaction), the search system uses a method using additional input information (e.g., herein may be referred to as “additional information”) provided by the user (e.g., the way interacting-with/tapping-on the large keys/zones of the keyboard) for refining a search result. Preferably, at first the system makes a first selection of titles based on the large key information. Preferably, thereafter, the system refines the selection by considering the/an additional information for selecting at least a number of titles among the selected titles and/or the order of the selected titles) for presenting a/the corresponding search result.

Optionally, the search system may use a method for changing the order of titles in a search result. Refining and/or changing the order of the titles of a search result may herein be referred to “enhancing” / “enhancement of”/“refining”a/the search result.

Optionally, enhancing a search result is made based on, for each character of a (e.g., one or more) word of a title, calculation of a distance between a desired/intended character on the large key and a corresponding interaction impact provided on a location of the large.

Optionally, enhancing a search result is made based on, for each character of a (e.g., one or more) word, in/for a corresponding keyword, considering the relationship between the location of an (e.g., a current) interaction impact and the location of a prior interaction impact on the keyboard.

### Serach

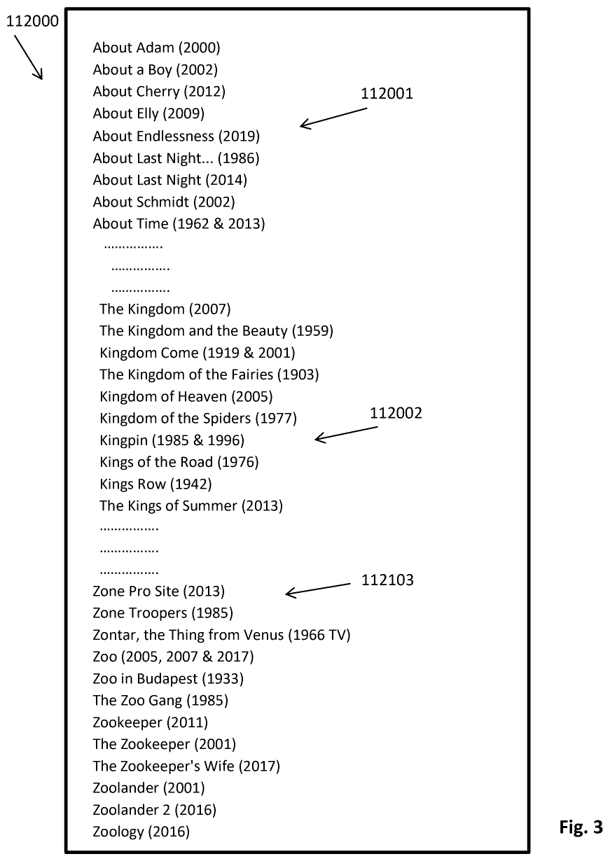

According to one embodiment of the invention, a searching system/application using the text entry system of the invention for searching textual contents may be created. As an example, but not limited to the example, search system may be used for searching (e.g., the titles of) (e.g., media) contents such as movies, songs, web pages, etc., on mobile and fixed devices (e.g., an thereafter activating a corresponding application/function such as activating a player to play a corresponding song/video, opening a corresponding content (e.g., a webpage), etc.). FIG. 3 shows as an example, portions 112001, 112002, and 112003, of a list 112000 of more than 44000 titles of movies as presented by/in the Wikipedia. Said database is herein may be referred to “exemplary database” and is used herein to provide examples of finding and presenting titles based on the principles of the search system of the invention.

As described before, each of the two large zones/key may be represented by a unique (different) input signal. As an example, by considering the keyboard of FIG. 2C, interacting with (e.g., any of the letter keys of) the left large zone 101201 may produce (e.g., or related (e.g., by the system) to) the digit “1”, and interacting with (e.g., any of the letter keys of) the right large zone 101202 may produce (e.g., or related (e.g., by the system) to) the digit “2”. Note that instead of the digits 1 and 2, other methods/symbols may be used by the text predictive system of the invention. As an example, instead of the digits 1 and 2, other characters such as letters L and R, digits 0 and 1, etc., may be used for representing an interaction with respectively, the (e.g. large) key/zone 101201 and the (e.g. large) key/zone 101202 of the keyboard of FIG. 2C.

Accordingly, the words of a title database may be represented/arranged by the digits 1 and 2. For example, in addition to be stored as is in a database, the word “hello”, may also be represented and/or stored (e.g., in a/the database) by the sequence of digits “21222” (e.g., such/a sequence of digits may herein may be referred to as a “digitized word” or a “keyword”) and, in addition to be stored as is in a/the database, the word “world” may also be represented and stored in a/the database by the sequence of digits “12121”. The length of a sequence of digits may have a direct impact on the accuracy of prediction of a corresponding title. A longer sequence of digits results in better prediction of the corresponding title. As such, the text entry system of the invention may be highly efficient for searching for a textual content (e.g. a movie title) among a database of textual contents (e.g., among a database of movie titles) because a textual content is usually comprised of a plurality of words and searching for preferably two words or more words means searching according to two or more sequences of keywords as described above.

By using the text predictive system/software of the invention and searching for any two or more (e.g., digitized) words (e.g., based-on/corresponding-to the entry of a sequence of digitized words corresponding to a sequence of interactions with the corresponding large keys (e.g. herein may be referred to as “keyword/s”)) of a textual content within a database of textual contents (e.g., by searching for any two or more (words of a movie title during a single search), the chances that the text predictive system of the invention correctly predicts and/or presents the desired textual content (e.g., movie title) becomes/is extremely high.

Note that, even if a title within a database may have only one word, because generally most of the databases (e.g., especially those stored and/or used in a mobile device) have at most a few thousands of titles, the search system of the invention may/is-adapted-to find a desired title and will present the title substantially among the top of a list of selected titles to a user.

Note that the word “textual content” used herein may preferably means a sequence of words of any kind such as text, and/or a sequence of group-of-symbols (e.g., digits, special characters, etc.), group of functions, and/or a mixture/combination of at least two of them, etc.

According to one embodiment of the invention, based on the principles of the data entry systems of the invention described herein, a software/application/system for searching textual contents among a database of textual contents may be created. For the purpose of describing such/said search system/application/software, said textual content may herein be described as a “title” (e.g., of a movie).

Based on the principles described above, only two (e.g., large) keys may be enough for searching for (e.g., textual) contents (e.g., phrases, titles, etc.) within a (e.g., approprate) database. Accordingly, different devices and/or interfaces having two (e.g., large) keys (e.g., to which at least the letters of an alphabet divided in two groups are assigned) may be designed and/or produced for searching titles within databases.

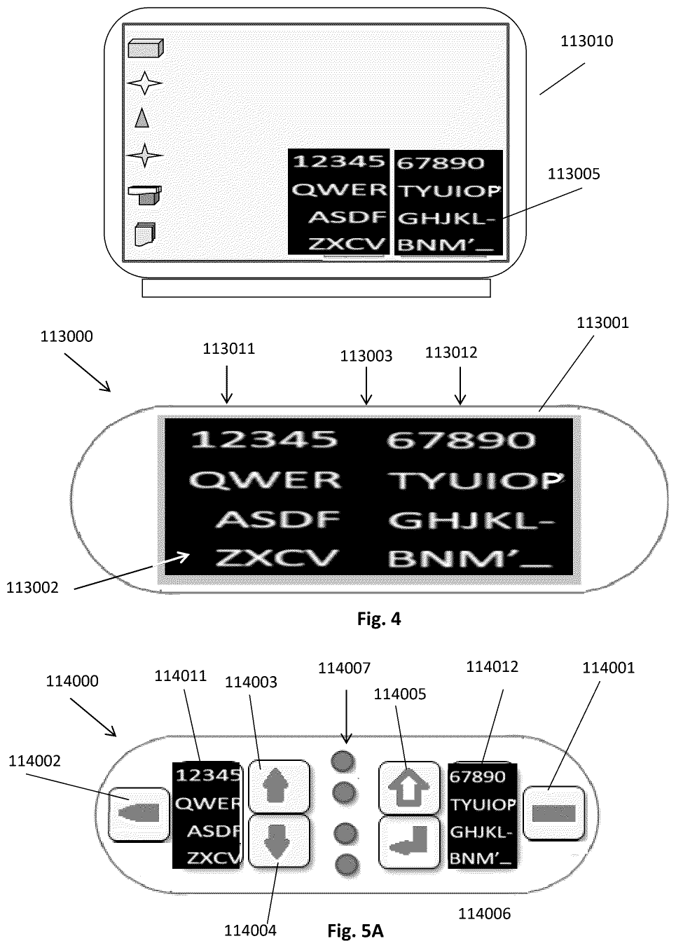

As an example, such search system may be used for searching titles of movies within a database of titles of movies. For that, the search system may preferably include and/or uses a movie titles database. Preferably, the words of the titles of movies may be organized/represented/arranged in the manner described above by a corresponding number of sequences of digits (e.g. herein may be referred to as a digitized titles). Optionally, a digitized title/word may be created during a search procedure. As an example, by considering the keyboard 113000 of FIG. 4, having two (e.g., left and right) large zones 1130111 and 113112, the words of the title of the movie “The picture of Dorian Grey”, included within a corresponding database, may be represented by respectively the plurality of digitized words/keywords as below:
“221 2212211 21 121212 2112”.

Such principle may be applied to all of the movie titles of a database of movie titles.

For searching said title, as an example, a user may provide a number of corresponding digitized words/keywords by providing pressing/tapping actions (anywhere) on the corresponding large zones of the keyboard 113000. As an example, for entering two words “picture” and “Dorian”, the user may press on:
a) right zone, right zone, left zone, right zone, right zone, left zone, left zone, for the word “picture”, and (e.g., after providing a space character (4.g., by pressing a space key, by providing a predefined swiping gesture on the screen/keyboard, etc.);
b) left zone, right zone, left zone, right zone, left zone, right zone, for the word “Dorian”.

Accordingly, said key presses may be transformed to two digitized words (e.g., herein may be referred to as “digitized keyword/s” or “keyword/s”) 2212211 and 12112 (e.g., together being a very long number of digits 2212211 and 12112 or, 12112 and 2212211). The system then, may search for titles having (e.g., words with) similar sequences of digitized keywords (e.g., by relating/matching said keywords to appropriate words of the titles) within a database of titles used by the system. The chances of finding many titles that (e.g., in a single title) some (e.g., in this case, two) of their (e.g., corresponding) digitized words match the digitized keywords entered by the user is very low. The system, then, may preferably provide/present the corresponding one or more titles (e.g., herein may be referred to as “selected titles”, search result, etc.) to a user, preferably on the screen of a corresponding device. Note that between said two keywords, preferably, an end of the word signal such as a space character is preferably/should-be provided.

According to a first aspect, after entering one or more keywords corresponding to at least some (e.g., one or more) words of a title, upon providing a predefined input signal (e.g., a Return” function) the search system uses said one or more keywords and proceeds to a searching procedure for searching for one or more corresponding titles. Thereafter, preferably, the system presents a corresponding search result including one or more corresponding (e.g., selected) titles to a user. According to a second aspect, each time a user types a keyword, upon providing an end-of-a-word signal (e.g., a space character), the system proceeds to a search procedure using said keyword and other previous keyword/s (e.g., if any) provided by the user for searching a desired title. According to a third method, each time a user provides an input signal (e.g., of a keyword) corresponding to a character of a word of a desired title, the system proceeds to a search procedure (e.g., in real time/on the fly) using the current (e.g., partial) keyword and other previous keyword/s (e.g., if any) provided by the user for searching a desired title.

If there are more than one corresponding titles that some (e.g., in this case, two) of their digitized words match the digitized keywords entered by the user, then the user may either navigate within the presented titles or he/she may provide one or more additional sequences of key presses corresponding to one or more additional words of the title (e.g., which may be processed as described above) for narrowing down the search and reducing the number of corresponding titles/candidates (e.g., to be presented on the screen).

After selecting the/a desired title/textual content (e.g., by a user), the system may access the content (e.g., a movie, a song, a document, etc.) corresponding to the selected title and execute a corresponding process (e.g., playing said movie on the screen of the corresponding device, playing the song, presenting a content on the screen, etc.).

Note that, the digitized words representing the words of the titles in a database of titles may not be stored in a/the database. In this case, according to one method, a digitized word of a title may be defined in real time during a corresponding search procedure.

Note that, if a word of a title is very long, providing (large) key presses corresponding to said word alone may be enough for predicting a corresponding/said title by the system.

According to one aspect, two or more sequences of key presses may be entered one by one (e.g., by providing an end-of-the-word signal such as by pressing the ENTER key between said sequences). As an example, a user may first enter a first word/keyword of a desired title. If the corresponding titles in the search result list (e.g., presented by the system on the screen) are large/significant, then, the user may enter a second word/keyword of said title to reduce the number of corresponding choices, and so on, until, preferably, only a few one or more words is/are presented by the system among which the desired title will be present for selection.

According to another aspect, two or more sequences of key presses may be entered together (e.g., one after the other, preferably, by pressing the SPACE key between said sequences).

Preferably, the order of providing entering (e.g. the key presses corresponding to) two or more words may be arbitrary. As an example, in the current example of title, the word “Dorian” may be entered before or after the word “picture”.

Note that, the search system of the invention may use any one or more features of the data entry system of the invention. According to a first aspect, for searching a title, a user may sloppily type on the corresponding left and right zones (e.g., for entering digitized keyboards) corresponding to one or more words of a desired title (e.g. until the title appears on the screen). According to a second aspect, the user may precisely enter at least one or more characters of a desired on or more words (e.g. and enter sloppily the one or more characters of the rest of the characters of said one or more words).

According to one aspect, the search application relies-on/considers only the pressing actions provided by a user on the left and/or right (e.g. large) zones for predicting/selecting one or more corresponding titles.

According to one embodiment of the invention, before and/or during and/or after presenting one or more titles to a user based on user's key/zone presses, the system may present a number of words (e.g. a word list) corresponding to a corresponding provided sequence of key presses to the user. Then, the user may select one of said words that corresponds to a/the desired title (e.g., herein may be referred to as an identified word) for better informing the system about the desired title. In this case, a title presented by the search application will preferably include the selected one or more identified words.

The current methods of search of titles used by the TV industry are very cumbersome. Most of the time an on-screen keyboard is displayed on the screen of the television and a user must navigate within said keyboard through a remote control for selecting the letters corresponding to a title, one by one. The search system of the invention solves the problem of search on TVs.

Looking at a TV screen requires the user's head to be “up” (e.g., watching/focused-on the TV). The search application of the invention may be used for searching titles (e.g., of movies, videos, etc.) on a TV quickly and easily while a user keeps his head “up”.

Because the user uses only two large zones/keys, he/she has just to press on two keys (if using one finger) or presses on a single (different) key with each finger (if using two fingers), therefore he/she can always can have his/or head “up”.

FIG. 4A shows as an example a device (e. g a remote control, etc.) 113000 having a touch sensitive screen/pad 113001 and an on-screen/a touch sensitive keyboard 113002. Said keyboard has two large zones 113011 and 113012. Said keyboard is used by the search and data entry systems of the invention for searching for (e.g., movie/video) titles and/or texting with others using the TV screen 113010 (e.g., and preferably, the communication system of the set-top box of the TV). For better interaction, an image 113005 of/reflecting the keyboard, showng the arrangement of letters on the left and right large keys of the keyboard 113000 used by the user is preferably displayed on the screen of the TV.

Note that for reducing mistyping, a gap 113003 is provided between the large left and right zones of the keyboard.

In this example, the keyboard does not have a space key or a backspace key and it substantially occupies the entire surface of the device so that to minmize the possibility of typing on a wrong key (e.g. such as an Space key). For entering/providing a backspace input, the user may provide a right-to-left swipe on the keyboard/screen/pad and for providing a space character, the user may provide a left-to-right swipe on the keyboard/screen/pad. For navigating within predicted/proposed titles, the user may swipe up and/or down on the keyboard/screen/pad.

Preferably, the middle row of letter-keys of the keyboard is narrower than other rows of letter keys. This is because, for interacting with a small upper or lower rows of keys, a user may move his/her fingers (e.g., slightly) up or down for pressing/interactig with the upper and lower rows of letter keys.

As shown, the remote control may have one or more (e.g., function keys) preferably physical keys.

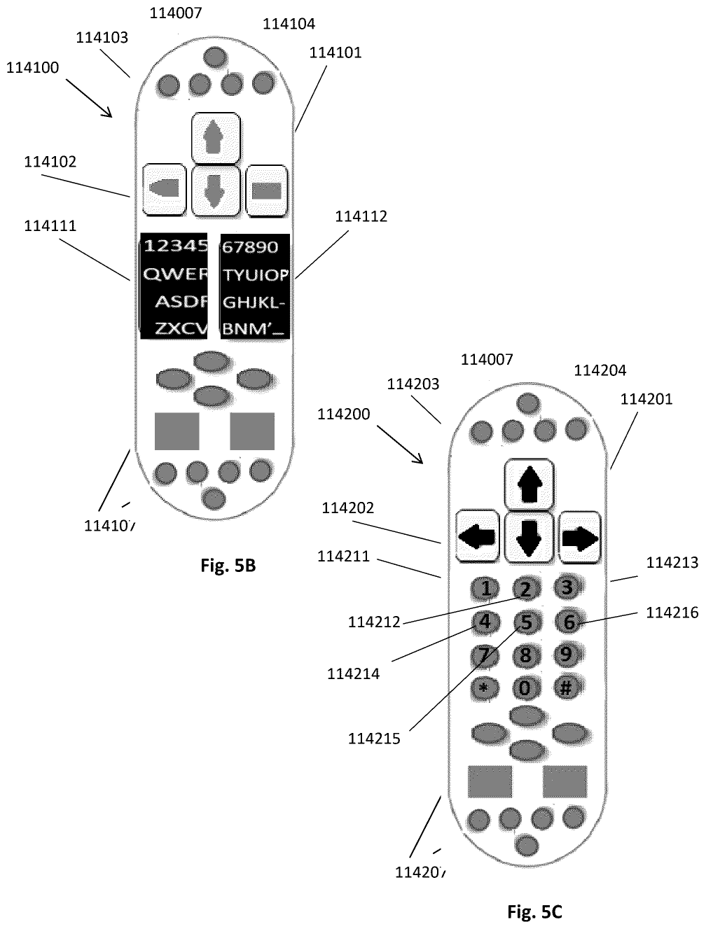

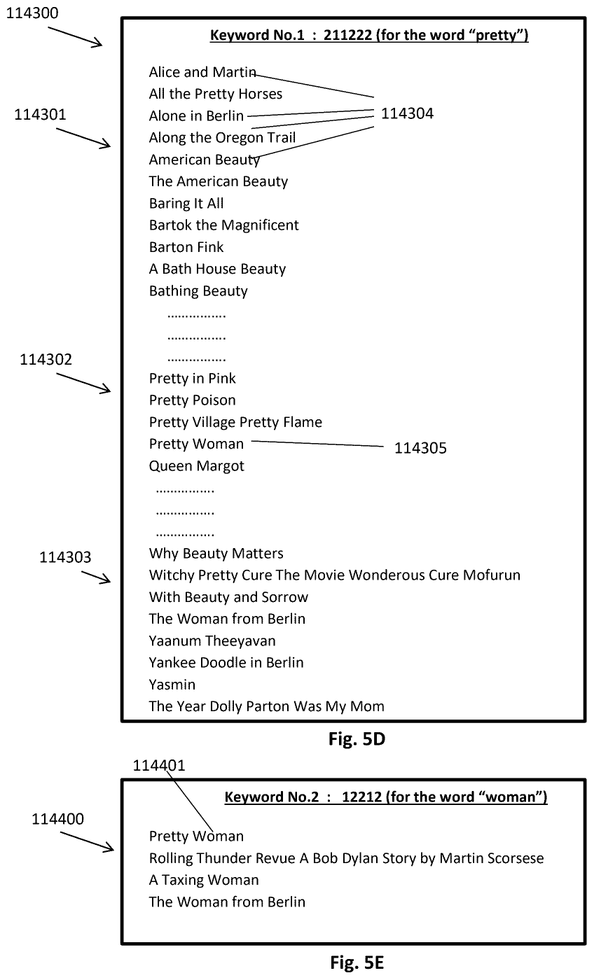

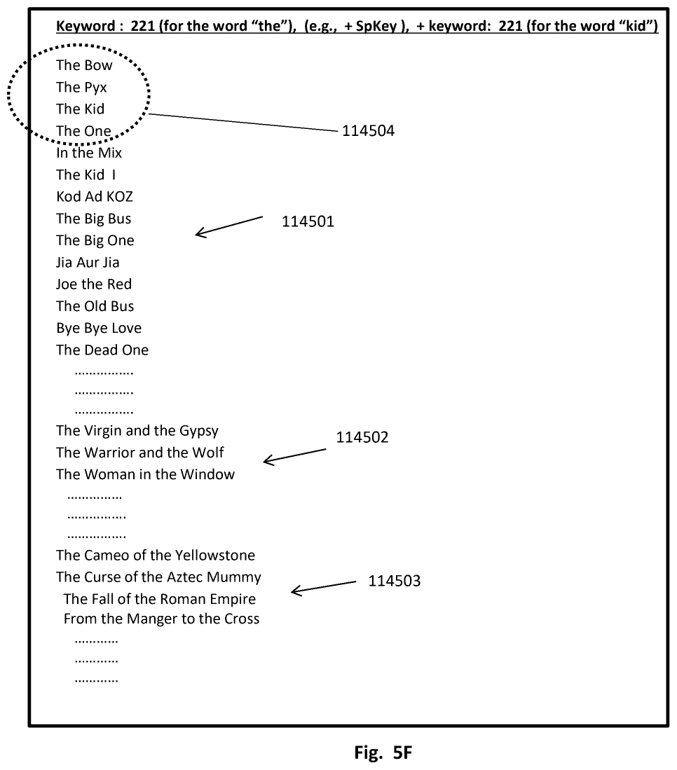

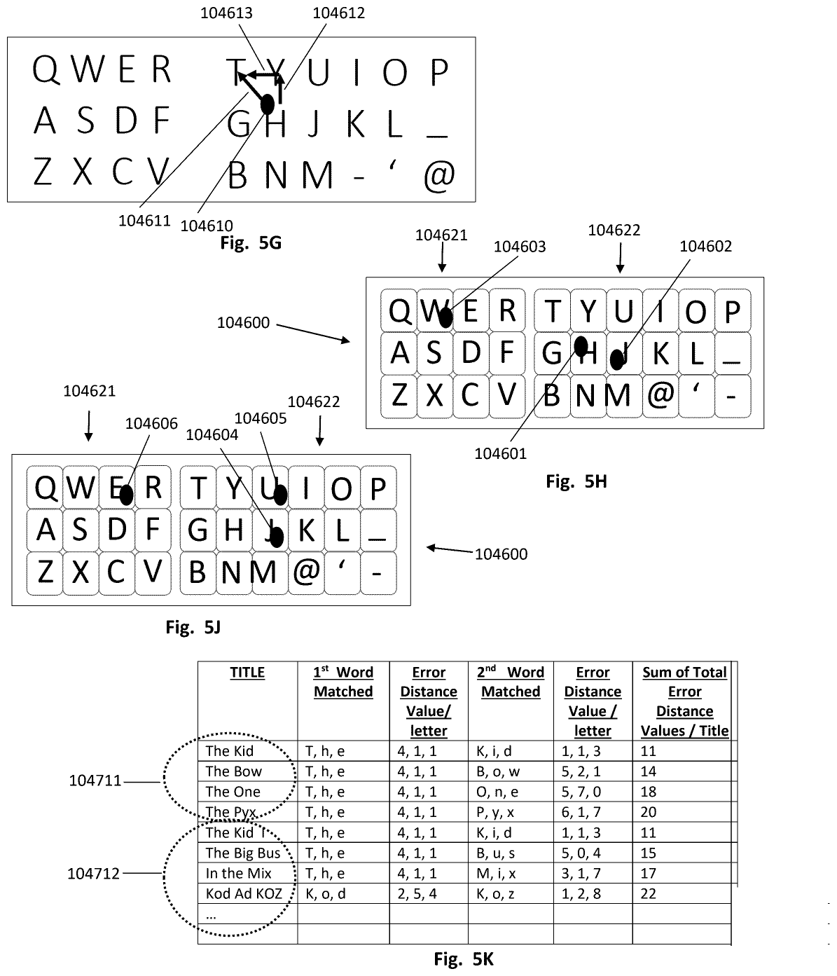

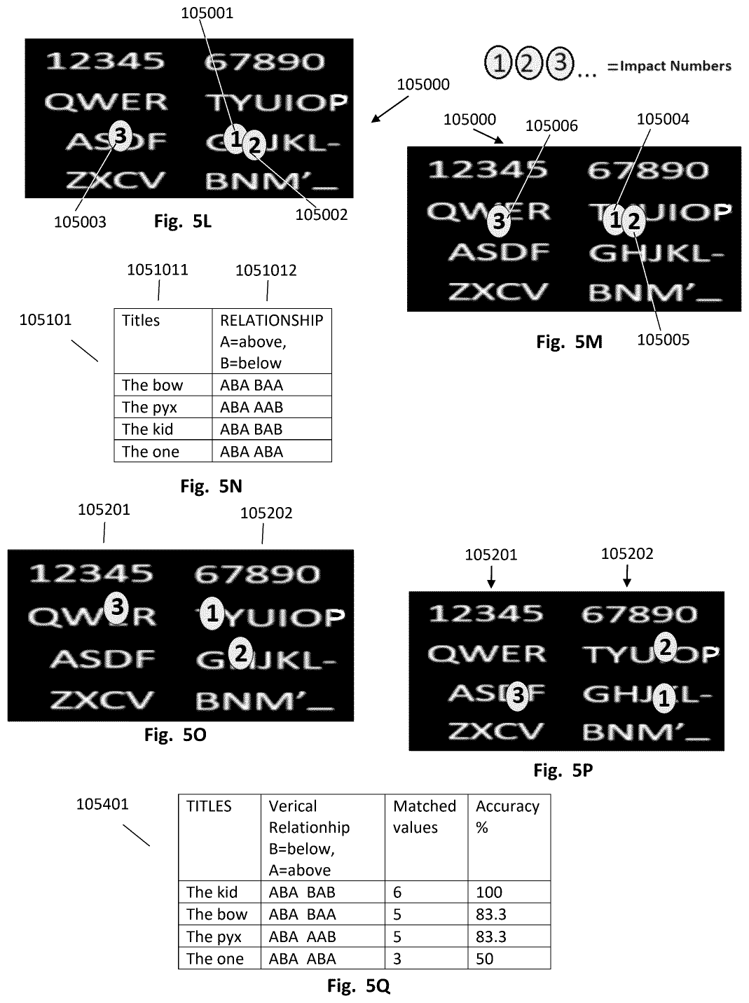

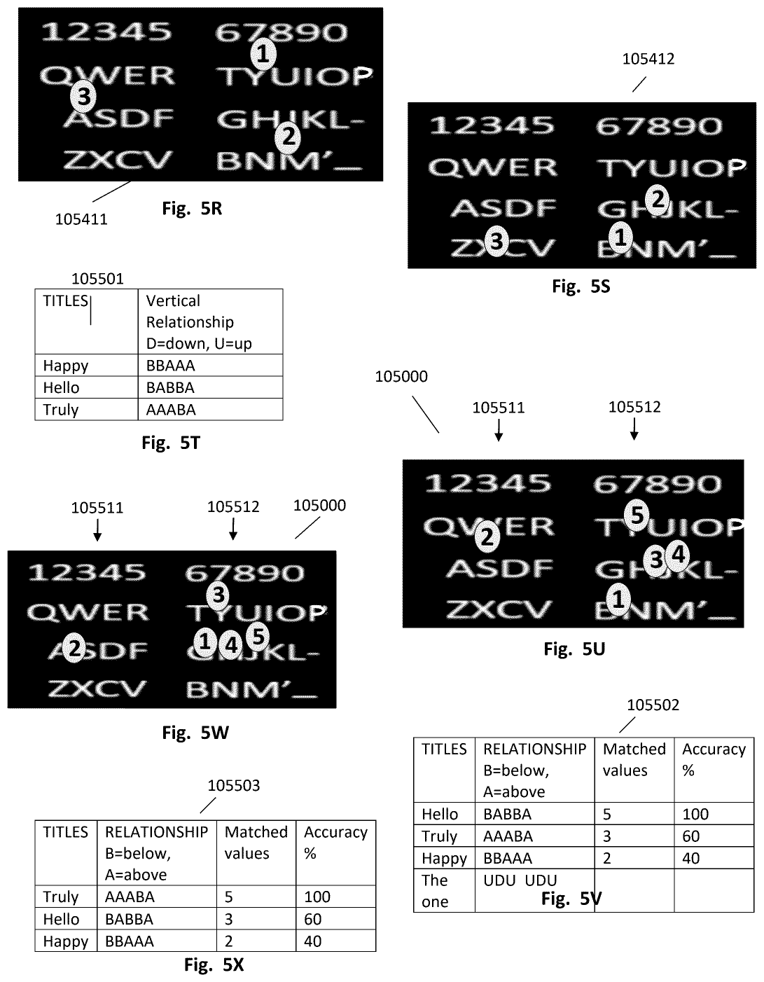

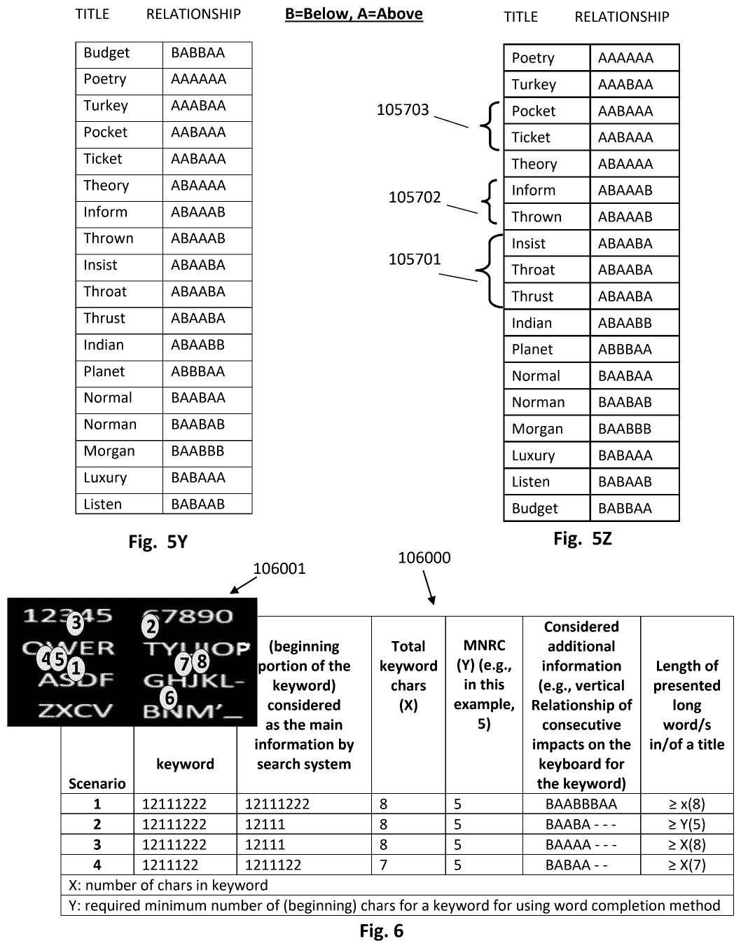

With continuous description of the principles of the current patent application, based on the principles described above, according to one aspect, only two (e.g., large) may be used for searching contents (e.g., phrases, titles, etc.) within a database of textual contents. Accordingly, different devices and/or interfaces having two (e.g., large) keys (e.g., to which at least the letters of an alphabet divided in two groups are assigned) may be designed and/or produced for searching within databases. FIG. 5A shows as an example, a remote control 114000 of TV, for use in lanscape position, having two (e.g., physical or virtual) letter-keys 114011 and 114012 to each of which a group of characters of a language are assigned. In this example, the (e.g., letter) key 114011 ambiguously represents the letters/characters that are assigned to the left (e.g., broadly ambiguous) large letter-key/zone 101201 of FIG. 2C, and the (e.g., letter) key 114012 ambiguously represents the letters/characters that are assigned to the right (e.g., broadly ambiguous) large letter-key/zone 101202 of FIG. 2C. By using only these two keys, a user may search a desired textual content (e.g., title) within a database of titles using/based-on the data/text entry system of the invention without the need of looking at the remte control while typing-on/pressing the (e.g., letter) keys having corresponding characters. While typing the corresponding keywords (e.g., digtal words) corresponding to a desired title, the user can continue to look at the TV screen (e.g., while keeping his/her «head-up»). As an example, key 114011 produces the digit «0» and key 114012 produces the digit «1». Based on one or more sequences of digits produced by tapping on key 114011 and 114012 for typing one more keywords corresponding-to/of a title, the search system using the text predictive system of the invention most probably may present a list of predicted titles including at most a few titles among which the desired title (e.g., almost always) is present. If the list is long (e.g., has many items/titles), the user may type an (e.g., one or more) additional keyword (e.g., corresponding to a word) of the desired title. In ths case, the search system of the invention will/may refine/enhance the search by considering said additional keyword (e.g. for an additional corresponding word of a title) and may produce a reduced list of corresponding titles including the desired title. Note that, in order to find and present a title to the user, said title must be included within the database used by the search system.

Note that, in many cases, the search system may find only one title for one or more keywords provided by a user.

With continuous description of the current embodiment, the remote control device may have additional keys such as a Space key 114001, a backspace key, 114002, the arrow keys 114003 and 114004, for example, for navigating upwards and downward within a list of movie titles presented by the search system, and some other keys including/such as the keys 114007 for controlling the TV.

FIG. 5B shows as an example, a remote control 114100 of TV, substantially similar to the remote control of FIG. 5A, but for use in portrait position. In this example, the remote control 114100 has has two letter-keys 114111 and 114112, similar to the keys 114011 and 114012 of FIG. 5A, to each of which a group of characters of a language are assigned.

According to one aspect, at least the two (e.g., large) letter-keys, preferably all of the keys, of a remote control used by the search system may be physical keys, providing a low-cost remote control device. According to another aspect, at least said two (e.g., large) letter-keys may be virtual/soft keys.

The broadly ambiguous keys/zone may be of any size. As an example, said keys/zones may be of a small size such as a few (5-10) millimeters. As an example, the search system of the invention may use a regular/existing remote control of a TV for searching titles. FIG. 5C shows, as an example, a remote control device 114200 having a number-keypad («numpad») representng digits 0 to 9. As and example, the (e.g., small) key 114211 may by used for representing/replicating/duplicting the left broadly ambiguous key 114111 of FIG. 5B, and the (e.g., small) key 114212 may by used for representing/replicating/duplicting the right broadly ambiguous key 114112 of FIG. 5B. A Plurality of (other) keys of an/the (e.g., existing) remote control device may be used by the search system of the invention for representing/replicating/duplicting other keys that can be used by a search procedure/system of the invention. As an example, the keys 114213 to 114216, may be used for representing/entering, respectively, a Beckspace, Space, Clear (e.g., New Search), and Return/Enter functions/characters. It is important to note, any other two keys of an existing remote control may be used for representing/repliating/duplicting any of the broardly ambiguous left and right keys/zones of the invention. It is undestood, that any (of said) funtions may be assigned to any (other) key of the/a remote control.

According to one aspect, the search application of the invention and the/a corresponding text predictive software of the invention may be implemented within a mobile device such as smartphone for accessing contents through the search system of the invention. According to one method, said device may be used as a remote control (e.g., as well).

The/a title may have/include any type of information. As an examle, a title oof a movie may have the name of a movie, the name of one or ore people (e.g. actor/s, producer, etc.) related to said movie), year produces, etc.

With regard to principles of the search system of the invention described herein, an exemplary search procedure of the invention is demonstrated below. As an example, for searching the movie title «Pretty Woman », according to one aspect, a user may enter two corresponding keywords one by one (e.g., by pressing the Return/Enter key after enterng each keyword).

By considering the keyboard of FIG. 5C, after providing a sequence of key presses 114212, 114211, 114211, 114212, 114212, 114212, (e.g., digitized keyword/input 211222) corresponding to the word «Pretty», (e.g., and pressing the Space key 114212), as shown in FIG. 5D, the search system of the invention may present a list of corresponding titles 114300 (e.g., from the corresponding/exemplary database of movie titles 112000 of FIG. 3). Note that in this example, because only one (e.g., digitized) keyword is entered, the presented list 114300 includes many movie titles. As such, in FIG. 5D, only exemplary portions 114301, 114302 and 114303, of the complete list of the corresponding prsented titles are shown. Note that the list 114300 includes titles that include words 114304 (e.g., Martin, Berlin, Oregon, Beauty, etc.) that corrrespond to the digitized keyword 211222.

With continuous description of the current example, the user, then, may enter the keyword «woman» by pressing the keys 114211, 114212, 114212, 114211, 114212 (e.g., corrsponding to digitized keyword 12212). Accordingly, the system may preferably present the titles that include words corresponding to both (e.g., digitized) keywords entered by the user. As shown in FIG. 5E, there are only four titles 114400 (e.g., among a list/database of more than 44000 movie titles as listed in/by Wikipedia) that correspond to the two entered keywords (e.g., 211222 and 12212). The title «Pretty Woman» 114401 is among the presented titles 114400.

It must be noted that, different methods of entering keywords may be considered with the search system of the invention. As an example, according to a first aspect, the keywords may be entered one by one, and the system may present a list of titles corresponding to the keywords entered after entering each keyword. According to a second aspect, the system may present a list of correspondng titles after enetering each keypress (e.g., corresponding to a character of a keyword). According to a third aspect, the user may enter a plurality of keywords (e.g. with space characers between the keywords), then may press an end-of-the-keywords signal such as pressing the Return/Enter key (e.g., 114216). Then the system may provide a list of titles corresponding to the entered plurality of keywords. Other aspects may be considered by people skilled in the art.

According to one embodiment of the invention, titles corresponding to one or more keywords entered by a user, wherein said titles are comprised of a number of words equal to the number of said one or more keywords entered by a user, are given priority over other titles corresponding to said keywords wherein said other titles are comprised of a larger number of words than said one or more entered keywords. According to one aspect of the invention, the system may, preferably, at first present the titles that are comprised of a number of words equal to the number of keywords provided by the user.

As an example, as shown in FIG. 5F, by considering the (e.g., broadly ambiguous) keys 114211 and 114212 or FIG. 5C, for searching for the movie title «The Kid», the user may provide (e.g., for the keyword «The») a sequence of keypresses on the keys, 114112, 114112, 1141121, (then, 114214, or 114216, respectively on Space key, or Return/Enter key), then (for the keyword «kid») the user may provide a sequence of keypresses on the keys, 114112, 114112, 1141121, (then, 114214, or 114216, respectively on Space key, or Return/enter key). The corresponding (e.g., entered) digitized keywords are «221», (e.g., then, Spece) and «221». Accordingly, the system may preferably present the titles that each include words that correspond to the both of the digitized keywords. According to a preferred aspect, as shown in FIG. 5F, the system may first present the titles that are comprised of a number of corresponding words equal to the number of keywords provided by the user. In tis example, two keywords are provided, therefore, the system at first presents the corresponding titles 114504 (e.g., including the desired title, «the kid») comprised of two words (e.g., only). Accrding to one aspect, (e.g., below said words 114504, or in a separate/next page), the system, may preferably (e.g., also) show addtional titles corresponding to the provided two keywords by the user. Because said additional titles are many/significantly-numerous, only exemplary portions 114501, 114502 and 114503 of said additional titles are shown in FIG. 5F.

As shown in in FIG. 5F, among more than 44000 movie titles (listed in/by Wikipedia) only four titles (e.g., 114504) each comprised of two (short) words corresponds to the two keywords provided by the user.

As demonstrated by the examples above, each digitized keyword is comprised of a sequence of digits. Among a large number of titles, generally, there may be only a few titles that are comprised of a single word corresponding to a provided digitized keyword. Accordingly, there may be only a few titles that are comprised of two word corresponding to two digitized keywords privided by a user. Same is true for titles with larger number of words.

Note that additional keywords may be entered/provided by a user for searching for a title comprised of many words. In this case, preferably most of the time, even a few number (e.g. 2 to 4) of keywords provided by a user may be enough for the system to find and present (e.g., within at most a short list of corresponding tiltles) the user's correspoding desired title (e.g., having any number of words). After/based-on considering (e.g., as potential candidates), by the system, a number (e.g., one or more) of titles (e.g., herein, may be referred to “selected titles”) that at least some, preferably all, of the words of each of said selected titles, correspond to (e.g., matches) a sequence of keywords entered by a user. According to one embodiment, each matched word may (e.g., dynamically) be given a first (e.g., corresponding) value, preferably, based on the number of characters of said/the word. For example, if a word has three characters the corresponding value may-be/is «3», and if the word has seven characters the corresponding value may be/is «7», etc. Preferably, a (e.g., predefined) bonus (e.g., (e.g., a predefined) value) (e.g., such as a coefficient) may be applied/given to a (e.g., value of a) matched word, peferably according-to/based-on the number of the characters of the word (e.g., the longer the word, the higher the coefficient). For example, a word that has three characters may be given no bonus, a word that has seven characters may be given a first (e.g., predefined) bonus (e.g., its value may be multiplied by 1.7), and a word with nine characters may be given a second/higher (e.g., predefiend) bonus (e.g., its value may be multiplied by 2.9), etc. Upon providing a sequence of one o more keywords by a user, the search application, by considering (e.g., calculating a grand total value based on a formula) parameters such as 1) the percentage of the characters of matched words of each title in regard to the total chatacters of the corrsponding title, 2) the total value of said title, 3) the frequency of use of said title, 4) an arbitrary priority given to said title (e.g., within the database), 5) etc., may sort the corresponding predicted titles in a descending order of their corresponding grand total and present said titles to the user.

Several methods (e.g., separately/independently, or at least some of said methods combined with each other) for presenting (e.g., displaying on the screen of a corresponding device or reading them through a text to speech system, etc. (e.g., herein may be referred to as “exemplary presentation methods”)) at least some of said selected titles to a user may be considered, such as the following exemplary methods:
a) According to one method, the system calculates the total number of related (e.g., matched) words of each selected title and stores a corresponding value (e.g., herein may be referred to as “first total value”) for each selected title. The system, then, preferably sorts the selected titles in a decreasing order of their stored first total values. Preferably, the system presents one or more of the sorted titles (e.g., with highest first total values) to a user. Optionally, the system presents all of the sorted titles to the user.
b) Preferably in regard to (e.g., optionally, regardless of) method (a), the presented/selected titles are (e.g., further) preferably sorted in increasing order of their total number of words (e.g., herein may be referred to as “second total values”).
c) Preferably in regard to (e.g., optionally, regardless of) method (a), the system calculates the total number of characters of related (e.g., matched) words of each selected title and stores a corresponding value (e.g., herein may be referred to as “third total value”) for each selected title. The selected/presented titles are (e.g., further) preferably sorted in a decreasing order of their stored third total values. Preferably, the system presents one or more of the sorted titles (e.g., with highest third total values) to a user.

Optionally, the system presents all of the sorted titles to the user.
d) Preferably in regard to (e.g., optionally, regardless of) method (a), the system calculates the total number of characters of each of the related (e.g., matched) words of each selected title that have a same number of related (e.g., matched) words and stores a corresponding value (e.g., herein may be referred to as “fourth total value”) for each selected title. The selected/presented titles are (e.g., further) preferably sorted in a decreasing order of their stored fourth total values. Preferably, the system presents one or more of the sorted titles (e.g., with highest fourth total values) to a user. Optionally, the system presents all of the sorted titles to the user.
e) Preferably in regard to (e.g., optionally, regardless of) method (a), for each selected title, the system calculates the total number of related (e.g., matched) words divided by the total number of words and stores a corresponding value (e.g., herein may be referred to as “fifth total value”) for each selected title. The selected/presented titles are (e.g., further) preferably sorted the selected titles in a decreasing order of their stored fifth total values. Preferably, the system presents one or more of the sorted titles (e.g., with highest fifth total values) to a user. Optionally, the system presents all of the sorted titles to the user.
f) Preferably in regard to (e.g., optionally, regardless of) method (a), for each selected title, the system calculates the total number of characters of the related (e.g., matched) words divided by total number of characters and stores a corresponding value (e.g., herein may be referred to as “sixth total value”) for each selected title. The system, further/then, preferably sorts the selected titles in a decreasing order of their stored sixth total values. Preferably, the system presents one or more of the sorted titles (e.g., with highest sixth total values) to a user. Optionally, the system presents all of the sorted titles to the user.
g) Preferably in regard to (e.g., optionally, regardless of) method (a), the selected titles that the order of position of at least some (e.g., preferably, all) of their words within a same title matches/corresponds-to the order of at least some of (e.g., preferably, all) of the corresponding keywords entered by a user, may preferably be given priority over selected titles that the order of position of at least some (e.g., preferably, all) of their words within a same title does not match/correspond-to the order of said keywords.
h) According to one aspect, each of the titles of a database may have a (e.g., at least one type (e.g., frequency of use, importance, arbitrary, etc.) of) priority value assigned to it. Preferably in regard to (e.g., optionally, regardless of) method (a), the system (e.g., further) sorts the selected/presented titles in a decreasing order of their priority values. Preferably, the system presents one or more of the sorted titles (e.g., with highest priority values) to a user. Optionally, the system presents all of the sorted titles to the user.

According to one embodiment, among the (e.g., selected) titles of a database, the system considers titles that their total number of related/matched words of each of them is equal to or higher than the corresponding keywords. In general, and specifically in the examples of methods described above, the term “highest values” within a group of values (preferably) means the values above/higher-than a (e.g., predefined or dynamically defined) threshold.

### Error Distance

According to one embodiment, during the entry of a title, after considering the user's interactions with the two large zones (e.g. and selecting a number (e.g. one or more) of the corresponding titles of a database of titles used by the system), the system may also consider location of the/said user's interaction impacts on the large zone(s) from the intended characters to propose the (e.g. one or more titles among the) best matched titles (e.g. from a/the corresponding selection of titles) by the system to the user. The distance between an impact and the intended character may herein be referred to as «error distance value». The sum of the error distance values of the impactes provided for the entry of a title may herein be referred to as «total error distance values».

Accordingly, one aspect may consist of prioritizing one or more titles (e.g. of said corresponding selection of titles) based on measuring the distance between each of the impacts of said user's interactions on a (e.g. large) key/zone and each corresponding character of a title (e.g. each of at least a number of words of the selection) (e.g. presented/displayed on a corresponding large zone) of said selection of titles for the corresponding user's impact (e.g. on a touch sensitive keyboard). For this purpose one or more methods of measurement may be considered (e.g. the method of prediction based on the distance as described herein may be referred to as semi-predictive system/mode) such as:
a) ‘exact measurement’: the distance between each character of a word of a selected title and a corresponding interaction impact provided by a user is preferably measured based on shortest (e.g. linear, a straight line) distance between the location of the character to be interacted on the (e.g., touch sensitive) keyboard (e.g., said character corresponding to a character of a word of a (e.g., selected) title) and the location of the corresponding user's (e.g., finger) impact on said keyboard. As mentioned, such distance is herein referres to as «error distance value».
b) ‘simplified measurement’: the distance (e.g. for each character of a word) may be measured based on the number of characters between the location of a desired character to be interacted on the touch sensitive keyboard corresponding to a character of a word and the character closest to the user's impact location (e.g. on said touch sensitive keyboard). As mentioned, such distance is herein referres to as «error distance value».

According to one embodiment of the invention, the error distance values described herein may be considered for in a priority of presentation given to a title. As an example, the system may calculate the sum of the total error distance value/s of word/s (e.g., herein may be referred to as “ ”) of each of selected titles in relation to a number of keywords entered by user for searching a title. According to a preferred method, the selected titles may be presented according to their ascending order of their sum of total error distance values (e.g., regardless of a/the (e.g. total) number of characters (e.g., letters) of a title).

According to a first method, preferably used for a touch sensitive keyboard (e.g., an on-screen keyboard), during entry of a keywords, when a user provides a (e.g., sloppy) tapping action on a keyboard in regard to a desired character, a/the distance (e.g., the error distance value) between a tapping impact on the keyboard and the desired/intended/character is preferably measured (e.g., as a straight line) from the (e.g., center of) said impact to the (e.g., center of the/a) zone/key corresponding-to/representing the desired character on the keyboard. FIG. 5G, shows an impact 104610 of a tapping action on an on-screen keyboard provided by a user for a desired character “T”. Different method for measuring the error distance value may be considered. According to the/said first method, the error distance is measured (e.g., as a straight line 104611) from the center of the impact 104610 to the center of a zone/key corresponding to the letter “T”.

According to a second method, preferably used for keyboards having physical keys, the error distance value is measured based on the number of keys to travel, horizontally and/or vertically, from an interacted key to an intended/desired key. As an example, in FIG. 5G, the error distance value is “2”, because, as an example, a user may first travel 104612 from the interacted key H to a first key Y and then travel 104613 from Y to a second key T. Note that in both methods described above, a penalty value (e.g., value “2”) may be added to the error distance value for travelling towards a key, vertically. In the current example, a penalty may be added to the error distance value for travelling vertically from the key H to the key Y), as such the error distance value for the first impact 104610 4 (e.g., 2+2). Note that according to one aspect, no penalty value may/will be added to the error distance value.

According to a third method (e.g., for a virtual/on-screen keyboard), the error distance value of/assigned-to a tapping action corresponding to a desired/intended letter within a title may be calculated as the sum of the following values (as defined in (a) to (c) below):
a) distance (e.g. in millimeter, in number of pixels, etc.) of the x position of the impact from the x position/coordinate of the/a center (e.g., point/pixel) of the letter within the corresponding word of a corresponding title, on the keyboard (e.g., herein may be referred to as “x-distance value”);
b) distance (e.g. in millimeter, in number of pixels, etc.) of the y position of the impact from the y position/coordinate of the center (e.g., point/pixel) of the letter within the corresponding word of a corresponding title, on the keyboard (e.g., herein may be referred to as “y-distance value”);
c) a penalty value (e.g., 0 to 300 percent) applied to the y-distance value;

Other methods of calculating the distance value may be considered by people skilled in the art based on the principles described above.

As an example of the second method described above, FIGS. 5H to 5K show (e.g., by using a keyboard 104600 having two large zones 104621 and 104622) the exemplary steps for searching the/a movie title “The Kid” within an exemplary movie titles database as follow:
a) FIG. 5H, shows the interaction impacts 104601, 104602 and 104603 of a user's sequence of sloppy typing/tapping actions related to a first desired word “The” on the keyboard 104600. In this example, the system considers that the corresponding first keyword is “221).
b) FIG. 5J, shows the interaction impacts 104604, 104605 and 104606 of the user's sequence of sloppy typing/tapping actions related to the desired second word “Kid” on the (e.g., same) keyboard 104600. In this example, the system considers that the corresponding second keyword is (also) “221”)

By considering the second method described above (e.g., and a penalty value “2” for each time travelling vertically from a first key to a second key), the order of presentation of a number of corresponding selected/matched titles may be presented based on the ascending order of the sum of total error distance values of the selected titles.

According to a first method, as shown in FIG. 5K, (e.g., a list of plurality of) the selected titles are presented in the ascending order of their sum of total error distance values. According to one aspect, the selected titles may be presented in different groups based on the number of words within each group. As an example, in FIG. 5K, the selected titles are divided within two groups of selected titles. In this example, at the top of the list, a first group of selected titles 104711 are those which the number of words in each title of the first group are equal to the number of the corresponding keywords entered by the user. The rest of the selected titles form a second group (e.g. shown partially) 104712 wherein each of the selected titles in the second group have more words than the number of said/the corresponding keywords. According to a second method the selected titles may be presented in the ascending order of their sum of total error distance values (e.g. regardless of the number of words comprising a title).

### Consecutive Letters Relationship

The letters arranged on a keyboard have a vertical and/or horizontal location relationship in regard to each other. According to one aspect of the invention, by using these principles a system for enhancing a search system of the invention may be created. Hereafter, I will describe such a system by using/considering a QWERTY keyboard and the vertical location relationship between two (e.g., consecutive) letters (e.g., herein may be reffered to as “vertical relationship”) but similar principles may be applied to, respectively, any other keyboard (e.g., such as an Alphabetical keyboard) and the vertical and/or horizontal location relationship between two (e.g., consecutive) letters. Note that, the principles of vertical letter relationship and/or horizontal letter relationship may be used by a content search system such as that of the current invention.

With continuous description of the current aspect, as an example, on a QWERTY keyboard, letter “W” is above the letter “X”. Also, the letter F is above the letter “X”, the letter “V” is below the letter “P”, etc. As such, the letters of a word have vertical relationship in regard to each other. Accordingly, by considering a QWERTY keyboard, in the word “stone”, the second letter “t” is above the first letter “s” on said keyboard, the third letter “o” is at the same level as the second letter “t”, the forth letter “n” is below the third letter “t”, and finally, the fifth letter “e” is below the fourth letter “n”. As such, to each of the letters of a word, one of the values “below” or “above” (e.g., herein may be referred to as a “vertical value”) may be assigned. Note that in the example of the word “stone”, because the second letter “t” is above the first letter “s”, then, to the letter “s”the vertical value “below”may preferably be assigned. Note that, because the third letter “o” is at the same vertical level than the second letter “t”, its vertical value may be considered to be the same as the letter “t”, which in the current example is “above”. As such, the word “stone” can be represented by the consecutive vertical values: below, above, above, below, above. For simplifying the specification in the current (e.g., aspect) of the invention, the vertical value “above” may be referred to as “A” and the vertical value “below” may be referred to as “B”. As such, the vertical values of the consecutive letters of the word “stone” may be considered to be/referred to as “BAABA”. It understood any other velue (e.g., may be used to define the below and/or above vertical and/or horizontal location definition of a (e.g., consecutive) character/letter definition.

### Impacts Relationship

According to one embodiment of the invention, by considering the principles of letter location relationship (e.g., vertical values) as described, in order to search for a title, in addition to considering the corresponding interacted impacts on the large zones, the location relationship between the consecutive impacts may preferably be considered. This may permit to extremely accurate search system while permitting a user to type extremely fast and sloppily on (e.g., the corresponding large zones of) a keyboard.

With continuous description of the current embodiment, as an example, FIG. 5L shows an attempt by a user for searching for his/her desire title by providing corresponding keywords “221”, and “221” by pressing/tapping-on the corresponding large keys for each keyword regardless of typing on specific locations on the corresponding large keys. FIG. 5L shows the user's interaction/tapping impacts 105001, 105002, 105003, provided on a keyboard 105000 during the entry of the first keyword in regard to a first word of his/her desired title and FIG. 5M shows the user's interaction/tapping impacts 105004, 105005, 105006, provided on the keyboard 105000 during the entry of the second keyword in regard to a second word of the desired title. (e.g., Note that preferably an input signal related to a space (e.g., by interacting with a space key, by providing a predefined swiping gesture (e.g., on the keyboard), etc.) character has been provided by the user between the two keywords). In response to the sequence of the keywords provided by the user, the search system has presented the corresponding results 105101 as shown in FIG. 5N without considering the vertical location relationship of the interaction/tapping impacts provided on the keyboard. In column 1011011 the corresponding titles are listed. In this example, the vertical location relationship of the letters of the titles of each title has not been considered for providing the result, nevertheless, for the information only, the vertical location relationship of the (e.g., consecutive) letters of the titles are shown in the column 1051012.

In the current example, as an example, the user's desired title has been the title “the kid”, which is in 3^{rd} position in the list of the search result. By combining/using the vertical location relationship of the invention with the search system of the invention using keywords provided through interacting with two large zones, a user can cause the system to augment the position of a desired title in a search result. For such purpose, a user may preferably type at least a portion (e.g., preferably, all) of the keywords to be entered for a desired title in accordance to (e.g., herein may be referred to as “by respecting”) (e.g., at least some, preferably, all of) the vertical location relationship of the (e.g., consecutive) letters (e.g., relating to each other) of the desired word. The number of correct/matched vertical values of the impacts (e.g., in comparison to the vertical locations relationship values of the corresponding (e.g., consecutive) letters in corresponding word/s in a title) provided for keywords being entered for searching a desired title is preferably considered by the system to provide an enhanced search procedure and present an enhanced search result to a user accordingly. As an example, in FIG. 5O, the user has provided a sequence of typing actions for entering a first keyword “221” corresponding to the word “the” by respecting the vertical location relationship of the consecutive letters of the word “the” on the keyboard. The impact “1” corresponding to the letter “t” is provided on the corresponding large key 105202. The impact “2” corresponding to the letter “h” is provided below the impact “1” (e.g., therefore, impact “1” corresponding to the letter “t” has been/is provided above the impact “1” on the large key 105202), and the impact “3” corresponding to the letter “h” is provided above the impact “2” on large key 105201/on the keyboard. In FIG. 5P, the user has provided a sequence of typing actions for entering another keyword “221” corresponding to the word “kid” by respecting the vertical location relationship of the consecutive letters of the word “kid”. The impact “1” corresponding to the letter “k” is provided on the corresponding large key 105202. The impact “2” corresponding to the letter “i” is provided above the impact “1” on the large key 105202 (e.g., therefore, impact “1” corresponding to the letter “k” has been provided below the impact “2” on the large key 105202), and the impact “3” corresponding to the letter “d” is provided below the impact “2” on the large key 105201. As such, the vertical values of the corresponding impacts on the keyboard 105000 corresponding to the first word and the second word are respectively, ABA and BAB. Accordingly, as shown in FIG. 5Q, in addition to considering the keywords 221 and 221, the system may preferably present the search result (e.g., 105401) by considering the vertical values of the corresponding impacts as well. Preferably, the search result list may be sorted and presented by descending order of the accuracy percentage of the number of matched vertical impact values of the impacts in regard to/in comparison to the vertical relationship of the letters of the corresponding/selected titles corresponding to the provided keywords “221” and “221”. In this example, all of the vertical values of the sequence of interaction impacts provided by the user in regard to the title “the kid” correspond to/matches the vertical location relationship of the letters of the corresponding words on the keyboard. As such, the title “the kid” may be presented at the top of the search result list. Preferably, accordingly, the second title in the list is the title “the bow” which five of the corresponding sequence of vertical values match the vertical letter values of the title “the bow”. The third title in the list is the title “the pyx” which five of the corresponding sequence of vertical values match the vertical letter values of the title “the pyx”. And finally, the fourth title in the list is the title “the one” which three of the corresponding sequence of vertical values match the vertical letter values of the title “the one”.

The tapping action respecting the (e.g., vertical) location relationship of at least some, preferably all, of the (e.g., consecutive) letters of at least some of the words of a desired title may be provided anywhere on a corresponding large key (e.g., regardless of (e.g., far from) the location of the corresponding letters on the large zone/keyboard). As an example, in FIGS. 5R and 5S, the interaction impacts corresponding to the desired title “the kid” are provided on arbitrary locations on the corresponding large keys but with-respect/in-accordance to the vertical location/position relationship of the consecutive letters of each desired word in the title. As such, the search result list will be the same (e.g., 105401) as that of the FIG. 5Q. Note that for defining whether a second impact is provided below or above a first impact, a predefined vertical threshold may be defined by/in the system. If a second impact is beyond said vertical threshold above a first impact, then the system may preferably consider that the first second impact is above the first impact. If a second impact is beyond said vertical threshold below a first impact, then the system may preferably consider that the second impact is below the first impact.

And, finally, if a second impact is within said vertical threshold (e.g., below or above the first impact), then the system may preferably consider that the second impact is in the same vertical level as the first impact (i.e., the second level is neither below no above the first letter.). In the example of FIG. 5R the impact “2” is beyond a predefined vertical threshold below the impact “1”, and the impact “3” is beyond the predefined vertical threshold above the impact “2”. Therefore, the vertical impact value of the first keyword is “ABA”. In the example of FIG. 5S the impact “2” is provided beyond a predefined vertical threshold above the impact “1”, and the impact “3” is provided beyond the predefined vertical threshold below the impact “2”. Therefore, the vertical impact value of the second keyword is “BAB”.

According to one embodiment, if all of the interaction impacts provided for entry of a keyword are provided within a predefined vertical threshold on a keyboard, then some scenarios may be considered:
1) If the impacts are provided above a predefined (e.g., virtual) horizontal line (e.g., positioned in a predefined location, preferably in the middle of a keyboard or elsewhere) on a large key/zone, the vertical value assigned to each of the impacts will be “A”. Accordingly, to each of the letters of a word of a database of titles used by the system wherein said letters are located on a same horizontal row of letters above said horizontal line on said keyboard, the value “A” is assigned.
2) If the impacts are provided below said predefined (e.g., virtual) horizontal line on a large key/zone, the vertical value assigned to each of the impacts will be “B”. Accordingly, to each of the letters of a word of a database of titles used by the system wherein said letters are located on a same horizontal row of letters below said horizontal line on said keyboard, the value “B” is assigned.

Note that a keyword may be comprised of or more input signals/digitized characters.

As mentioned before, the principles of letter location relationship may be applied to, both, vertical and horizontal location of the letters on a keyboard and a corresponding sequence of tapping actions for entering the input information corresponding to a desired word. As an example, in FIG. 5S, the tapping impact “2” is provided beyond a (e.g., predefined) horizontal threshold on the right side of the tapping impact “1”. This corresponds to the corresponding the horizontal location relationship of the (e.g., first and second) letters of the word “bow” (e.g., which is not the case of the corresponding letters of the of the word “pyx). The third tapping action “3” is provided on the left side of the impact “2”. By considering, both, the vertical location values and horizontal location values of the impacts on the keyboard of FIG. 5S, the system may preferably present the title “the bow” above the title “the pyx”, in the result list, even though both of the titles have the same vertical location values.

Another example based on principles of the current aspect is described through FIGS. 5T to 5X. FIG. 5T shows a portion 105501 of a list of selected titles corresponding to a/the keyword “21222” without considering the vertical values of the corresponding tapping impacts on the keyboard 105000. FIG. 5U, shows as a first example, the tapping impacts, corresponding to the desired title “hello”, provided by a user. The first impact “1”, is provided on the corresponding (e.g., right) large key 105512. Its vertical value is still uncertain (e.g, according to one aspect, the system may assign a (e.g., temporary) vertical value (e.g., “U” or any other predefined value) to an uncertain/undifined (e.g., vertical and/or horizontal) location impact. The following impact “2” is provided (e.g., on the large key 105511) beyond the predefined vertical threshold above the first impact “1”, therefore the corresponding impact value is “A”. As such, the vertical value of the first impact “1” will be assigned/defined as “B” (e.g., changed from “U” to “B”) by the system because it is provided beyond the predefined threshold below the impact “2”. The impact number “3” is provided (e.g., on the large key 105512) beyond the predefined vertical threshold below the impact number “2”, therefore its given vertical value by the system is “B”. The impact number “4” is provided (e.g., on the large key 105512) within the range of the predefined vertical threshold from the previous impact “3”. As such, the value given to the impact “4” is the same as the one given to the impact “3”, which is “B”. Finally, the impact number “5” is provided (e.g., on the large key 105512) beyond the predefined vertical threshold above the impact number “4”, therefore, its vertical impact value will be “A”. As such, the keyword 21222 vertical impact value will be “BABBA”. The letter vertical values of the title “hello” matches the best the keyword vertical value (e.g., 5 out of 5 in other words 100% correct/matched). In FIG. 5V, table 105502 shows the search result for the provided keyword. Accordingly, the word “hello” is at the top of the list. The word “truly” is positioned in second place because 3 of 5 vertical impact values matches the vertical letter values of the word “truly”, and the word “happy” is positioned in the third place because 2 of 5 vertical impact values matches the vertical letter values of the word “happy”.

FIG. 5W, shows as another example by considering the table of 105501 FIG. 5T. In this example, the tapping impacts corresponding to the desired title “truly”, are provided by a user on the keyboard 105000. The first impact “1”, is provided on the corresponding (e.g., right) large key 105512. Its vertical value is still uncertain/undefined. The following impact “2” is provided within the predefined vertical threshold in relation to the vertical location of the first impact “1”, therefore its corresponding impact value is also uncertain yet. The impact number “3” is provided beyond the predefined vertical threshold above the impact number “2”, therefore its given vertical value by the system is “A”. Accordingly, the vertical value of the impact “2” which is beyond the vertical threshold below the impact “2” will be “B” and accordingly the vertical value of the first impact “1” will be “B” as well. The impact number “4” is provided beyond the predefined vertical threshold below the previous impact “3”. As such, the value given to the impact “4” is “B”. Finally, the impact number “5” is provided within the predefined vertical threshold in regard to the impact number “4”, therefore, its vertical impact value will be “A”. As such, the keyword vertical value will be “AAABA”. The letter vertical location values of the title “truly” matches the best the impact location values of the provided keyword. Table 105503 of FIG. 5X shows the search result of the provided keyword 21222 by considering the vertical values of the corresponding impacts. Accordingly, the title “truly” is positioned at the top of the presented list, and the titles “hello” and “happy” are presented in, respectively, second and third position according to their descending percentage of the matched impact vertical values.

The current aspect, significantly augments the accuracy of the search system for finding with little help from the user. The system just requires that the user provides at least a portion of the corresponding impacts in respect/in accordance to some, preferably all, of the vertical location relationship of the consecutive letters (e.g., of at least some of the words) of the desired title on a corresponding keyboard. In FIG. 5Y shows, as an example, the words (e.g., included in different titles) that correspond to the keyword 221212 and their letter vertical location values on a QWERTY keyboard. The same words are sorted in FIG. 5Z according to the descending order of their letter vertical location values. As shown, among said words, only three of the words 105701 have an identical letter vertical value, only two of the titles 105702 have a first identical letter vertical value, and only two others of the titles 105703 have a second identical letter vertical value. The rest of the words each have a different vertical value.

The seach system of the invention using a keyboard having two large keys and using the vertical relationship between the (e.g., consecutive) impacts is a very easy to use with extremely accurate search result. As an example, by considering the keyboard 105000, FIG. 5Z1, shows as an example, all of the titles related to the keyword “2112” (e.g., provided by a user's interaction on the keyboard 105000) from a database of titles of songs (e.g., from a “playlist” database) comprised of about 2000 titles. Let's assume that the user's intention has been the title “hero” and has provided the vertical interaction impacts accordingly. In this case, the (e.g., keyword's) vertical relationship value of the impacts is “BAAA”. By considering the keyword's digitized value “2111” and keyword's vertical impacts value “BAAA” (e.g., herein may be referred to as “combined input information), only nine titles 105801-105809 in the entire database of about 2000 titles match the combined input information. Furthermore, if we assume that the user has opted for the “in-order” method, only four titles 105801, 105805, 105806 and 107807 will be slected (e.g., and presented to the user) by the search system of the invention, for only one short keyword.

In the example above, assuming that the user had desired andother (e.g. a longer title) “keep on loving you” 105007, providing a very short next keyword “22” corresponding to the word “on” would have been enough for the system to precisey select (and present to the user) ONLY one title “keep on loving you” from 2000 titles. Note that, furthermore, if the system also would have used, as well, the horizontal impacts relationship of the provided impacts, the number of selected/matched titles would have been much less.

In the example above a short keyword had been provided. It is understood that providing a longer keyboard would result in matching/finding less number of corresponding titles by the search system. In FIG. 5Z2, a combined input information consisting of the keyword “121111 and the corresponding impact values “ABABAB” has been provided by the user for searching a title from the same database of about 2000 titles of songs. In this example, (without opting for the “in-order” method by the user) the search sysyem has selected/matched (e.g., could find) only two titles 105811 and 105812 corresponding to said keyword and the corresponding vertical impact values “ABABAB”.

According to one embodiment, the vertical value assigned to a first impact of a sequence of impacts corresponding to a keyword may be assigned according to its vertical position in relation to the (e.g., virtual) horizontal line. As an example, if the said first impact is provided above said horizontal line, the vertical value “A” will be assigned to the first impact. Accordingly, if the said first impact is provided below said horizontal line, the vertical value “B” will be assigned to the first impact. The assigned value to the first impact may thereafter be modified/changed based on its vertical relationship to one of the following impacts related to/provided for said keyword.

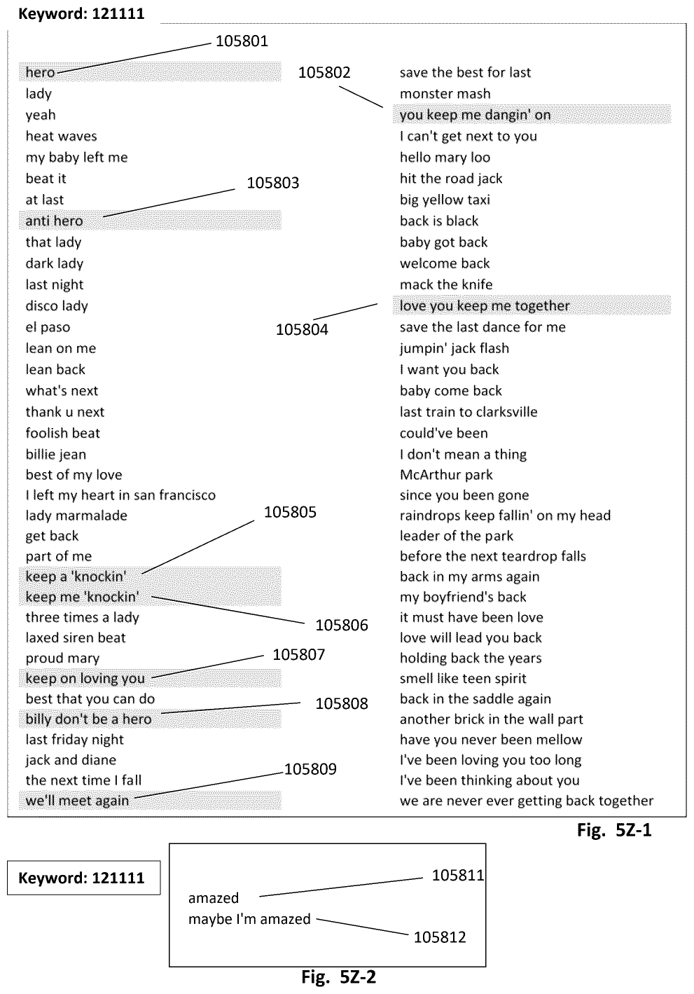

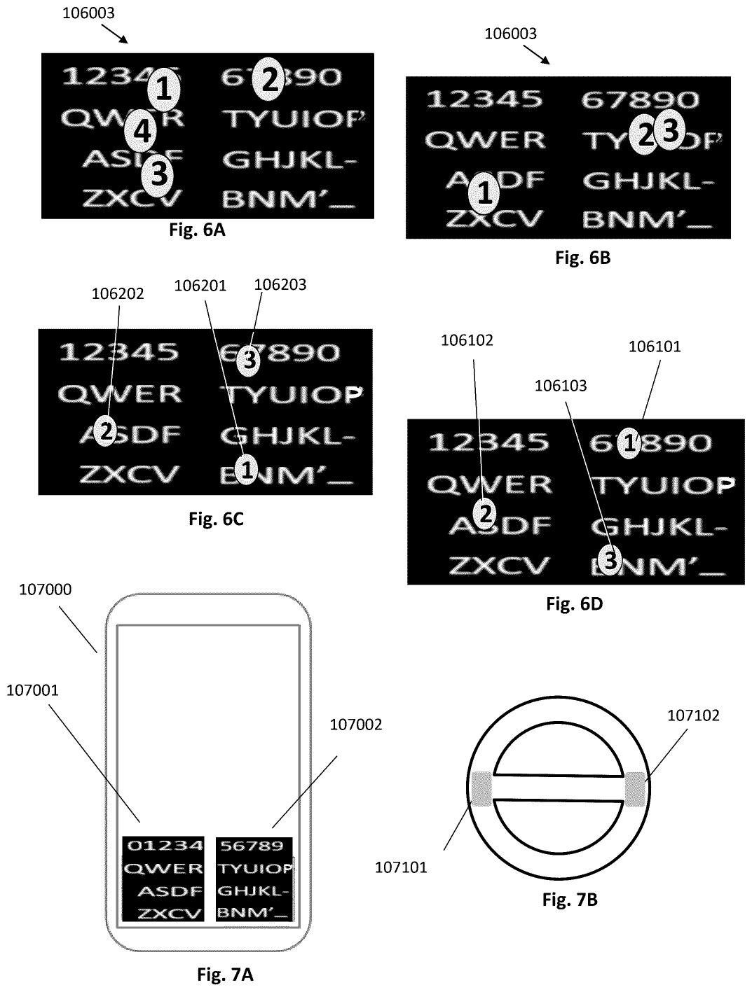

According to one aspect, if a “above” vertical value is already assigned to an impact, the following impact provided above said an impact will be assigned the “above” vertical value as well. As an example, in FIG. 6C, the impact “2” is provided above the impact “1”, therefore the vertical value assigned to the impact “2” is “above”. In this example, the following impact “3” is provided above the impact “2” to which the vertical value “above” is already assigned. In this case, the system assigns the vertical value “above” to the impact “3”, as well. On the other hand, if a “below” vertical value is already assigned to an impact, the following impact provided below said an impact will be assigned the “below” vertical value as well. As an example, in FIG. 6D, the impact “2” is provided below the impact “1”, therefore the vertical value assigned to the impact “2” is “below”. In this example, the following impact “3” is provided below the impact “2” to which the vertical value “below” is already assigned. In this case, the system assigns the vertical value “below” to the impact “3”, as well.

According to one embodiment, the vertical values assigned to consecutive characters of a word within a database used by the may be defined by assigning different vertical values to the second character of two consecutive characters based on whether the second character is whether or not the second character is located on a row which is adjacent to a row below and/or above a row on which the first character of the two consecutive characters is located.

Accordingly, according to one embodiment, (e.g., at least) two thresholds values, wherein the first threshold is lower than the second threshold value may be considered, may be used for assigning different vertical values to consecutive interaction impacts provided by a user on a keyboard for/when entering a keyword. As an example:
if a vertical distance (value) between two interactive impacts is greater than the second threshold (e.g., herein may be referred to as “far”) wherein wherein the second interaction impact is above the first interaction impact, a first vertical value (e.g., “top”or “T”, etc.) may be assigned.
if a vertical distance (value) between two interactive impacts is between the first and the second thresholds wherein wherein the second interaction impact is above the first interaction impact, a first vertical value (e.g., “above” or “A”, etc.) may be assigned.
if a vertical distance (value) between two interactive impacts is greater than the second threshold wherein wherein the second interaction impact is below the first interaction impact, a first vertical value (e.g., “Lowest” or “L”, etc.) may be assigned.
if a vertical distance (value) between two interactive impacts is between the first and the second thresholds wherein wherein the second interaction impact is below the first interaction impact, a first vertical value (e.g., “Below” or “B”, etc.) may be assigned.

As an example, by considering the keyboard 101300 of FIG. 2D having two large zones/keys 101301 and 101302, the vertical values assigned to the consecutive characters of the word “rivoli” will/may-preferably be TTLTBA. This is because:
the vertical value of the third letter “v” in the word “rivoli” is L because the letter L is located on the lowest row of the keyboaes far from the first and second characters “ri” which are located on the toppest row of the keyword.
Accordingly, the vertical value of the first and second characters “ri” of the word will be TT.
The fourth character “o” of the word is located on the toppest row of the keyboard far from the third character “v” of the word which is located on the lowest row of the keyboard. Therfore, the value “T” is assigned to the fourth character.
The fifth character “l” of the word is located in the middle row of the keyboard which is adjacent below the toppest row of the keyboard on which the fourth character “o” is located. Therefore, value “B” is assigen to the fifth character.

The sixth character “i” of the word is located in the toppest row of the keyboard which is adjacent above the middle row of the keyboard on which the fifth character “l” is located. Therefore, value “A” is assigen to the fifth character.

According to one embodiment, for presenting the/a search result. in addition to considering the corrsponding words within a database of titles used by the search system wherein each of said words has a number of characters equal to the number of characters of the keyword, the search system may also preferably consider words of the database that have a larger number of characters (e.g., herein may be referred to as «longer word/s») than the keyword and wherein the beginnig character (e.g., herein may be referred to as «beginning portion ») of each of said words corresponding to the keyword. As such, the input information (e.g., interactions with the large keys for entering a keyword and preferably, one or more of selection enhancement principles such as those described herein, etc.) corresponding to a (e.g., one or more words) of a title may be related to an entire word and/or it may be related to a portion, preferably to a beginning portion, of a word. Note that, the beginning portion of a longer word is preferably considered to be a beginning portion of a longer word wherein said portion has a same number of characters as that of the entire (e.g., corresponding) keyword.

According to one method, the search system may search for words (e.g. in the entries of a database of titles) that their entire characters correspond to the (combined) input information (e.g. herein may be referred to as «short search» method/system) and/or longer words that a/the beginning portion of the word/s correspond to the (e.g., combined) input information provided by a user (e.g., herein may be referred to as «long search/word-completion» method/system). Different scenarios may be considered. As an example, by considering the table 106000 of FIG. 6 at least the some exemplary scenarios may be considered that will be described hereafter. In FIG. 6, the following definitions is used:
letter «x» represents the total number of characters of a (e.g., any) keyword (e.g., provided by a user)
letter «y» represents a (e.g., predefined or dynamically defined) minimum number of characters required for a keyword (e.g., herein may be referred to as «MNRC») as a condition for the search system to use a word-completion/long search method (e.g., in addition to a short search method). A keyword having at least a MNRC may herein be referred to as a «long keyword», and a keyword having a number of characters less than a/the MNRC may herein be referred to as a «short keyword».

With continuous description of the current embodiment, as an example, if user enters a keyword (e.g., «12111222», interaction impacts 1, 2, 3, 4, 5, 6, 7, 8 with keyboar 106001) having an x (e.g., 8) number of characters wherein the MNRC is five (5), at least the following word completion scenarios may be considered by the search system of the invention (e.g., note that in the scenarios below, the order of the keyword/s correspond/s to the order of the word/s within a title):
Scenario 1): the search system uses the main information and an additional (e.g., vertical relationship of consecutive impacts) information (e.g., together, the «combined information») relating to an (e.g., at least one) entire keyword provided by a user for identifying corresponding short words and/or longer words in order to providing a corresponding enhanced search result. As an example, by considering the keyword 12111222 using keyboard 106001 of FIG. 6 and a database of titles (e.g., not shown) comprising the names of the streets (e.g., streets, boulevards, places, etc.) of Paris (FR), the system may propose at least the following choices:
Strasbourg Boulevard de
Corvetto Rue
Charenton Rue de
Dufrenoy Rue

Note that in this example, the considered short words have the same number of characters as the keyword. Note that in this example, only the title word Strasbourg complies with the main information and the additional (e.g., vertical relationship of consecutive imacts) information, therefore said title is presented on the top of the list.
Scenario 2): in this scenario, the search system (e.g., only) considers the MNRC (e.g., 5 beginning charcters of the keyword 12111222), ignores the rest of the characters of the keyword and uses the combined information relating to the MNRC and the database of titles comprising the names of the streets of Paris, the system may propose at least the following choices:
Duras Rue de
Strasbourg Boulevard de
Forest Rue de
Clavel

Note that in this example, the considered short words have the same number of characters as the MNRC. As such, in this case, typing the five beginning characters 12111 (e.g., having a same vertcal tapping relationship) provides the same search result as any long keyword wherein their beginning characters is 12111. Note that in this example, only the words Duras and Strasbourg complie with the main information and the additional (e.g., vertical relationship of consecutive imacts) information, therefore said titles are presented on the top of the list.
Scenario 3): in this scenario, the search system (e.g., only) considers the MNRC (e.g., 5 beginning charcters of the keyword 12111222) and uses the combined information relating to the MNRC and the database of titles comprising the names of the streets of Paris, the system may propose at least the following choices:
Strasbourg Boulevard de
Cheverus Rue du
Chevereuse Rue du
Chazelles Rue de

Note that in this example, the considered short words have the same number of characters as the keyword. The rest of the characters (e.g., «rus») of a corresponding word (e.g., «Cheverus») of a title are regardless of the remaining characters of the keyword. Note that in this example, only the word Strasbourg complies with the main information and the additional (e.g., vertical relationship of consecutive imacts) information, therefore the corresponding title is presented on the top of the list.
Scenario 4): in this scenario, the search system considers the combined information corresponding to MNRC (e.g., 5 beginning charcters) of the keyword 1211122), additionally, (e.g., only) consideres the rest (at least one, preferably, all) of the characters (e. g, 6th and 7th characters (e.g., 22)) of the keyword 1211122), and uses the database of titles comprising the names of the streets of Paris, and may propose at least the following choices:
Strasbourg Boulevard de,
Chardin Rue,
Charcot Rue,
Coevetto Rue,
Chazelles Rue,
Cordoliers Rue,
Chardon Lagache Rue,
Chevaliers Impasse des,
Chevallier de la Barre Rue du,
Chevallier de Saint George Rue du,
Charenton Rue de, Charente Quai de la,
Dufrenoy Rue, Duvergier Rue,
Sizerins Villa des,
Diderot Boulevard,
Riverin Cite.

Note that in this scenario, the characters (e.g., «ot» of a presented word (e.g., «Diderot») other than those related to MNRC, corresponding to the last characters (e.g., 22) of a keyword (e.g., 1211122) are regardless of the vertical relationship of said last characters (e.g., 22) of the keyword. Note that in this example, the considered short words have the same number of characters as the number of characters of the entire keyword.

Note that, in any of the examples above, at least an additional second keyboard may also be provided by a user. As an example, in scenario (4), if the user provides an additional keyword 2221, only the title «Riverin Cite» corresponds to the main information.

Note that any of the scenarios 1 to 4 has its own advanages. As an example:
in scenario 1, (e.g., in addition to a (e.g., one or more) short keyword/s (e.g., if any)) the user may type/provide a (e. g, one or more) long keyword/s. In this scenario, the main information and a (e.g., corresponding) additional information of the entire (e.g., long) keyword are, both, considered by the search system to provide a (e.g., corresponding) search result.
in scenario 2, (e.g., in addition to a (e.g., one or more) short keyword/s (e.g., if any)) the user may type/provide a (e. g, one or more) long keyword/s. In this case, the main information and additional information of (e.g., only) a MNRC (e.g., 5 characters) of the long keyword are both considered by the system. The rest of the characters of the keyword, if any, are ignored by the search system. In this case, even if a user makes errors by tapping on wrong large keys for entring said rest of characters of the keyword, said error does not affect the search result. In this example, the search result may include longer words (e.g., each) having at least a number of characters equal and/or greater than a threshold (e.g. MNRC).
scenario 3, resembles to scenario 2, with the difference that here, the search result may include longer words (e.g., each) having at least a number of characters equal and/or greater than the keyword.
in scenario 4, the user can type/provide a (e. g, one or more) long keyword having any number of characters. In this case, the main information and additional information of only a MNRC (e.g., 5 characters) of the long keyword are both considered by the system. In this scenario, (e.g., only) the main information of the rest of the characters of the keyword are also considered by the search system. In this scenario the user does not have to worry about the additional (e.g., letter relationship) information of the rest of the characters of the keyword. In this example, the search result may include longer words (e.g., each) having at least a number of characters equal and/or greater than the corresponding keyword.
Note that the MNRC may predefinitly and/or automatically/on the fly defined based on parameters such the valoume of the (e.g., titles of) database and/or the length of the words (within the titles) of the database, etc.

Note that a MNRC may be any predefined number (e.g., 1, 2, 3, 5, 5, etc.). The MNRC mat be a predefined number of it may dynamically defined by the search system (e.g., based on the total number of the titles/words in a database used by the search system, (e.g., average) length of the words of the title, etc.).

### Total Value of Keywords Corresponding to Total Number of Beginning Characters of One or More Words (e.g., of Any Size, for Short and Long Words)

According to one embodiment of the invention, a threshold value consisting of a total number of the characters of one or more keywords corresponding to the beginning characters of a one or more words of a title (e.g., herein may be referred to as «total vertical values threshold») may be used with the content search system of the invention for finding a (e.g., plurality of (e.g., one and/or more) desired title (e.g., and presenting desired said title within (e.g., at the top of) a search result. As and example, by considering the database of names of the streets of Paris, (which includes about 6700 entries/titles), a threshold of (e.g., at least) one or more keywords wherein the total number of the characters of said keywords is ≥eight (7) (e.g., threshold value=7) is most of the times/practically enough for the search system of the invention using the corresponding main information and the/an additional (e.g., vertical relationship of consecutive imacts) to predict a corresponding/desired title. As an example, by considering the database of streets of Paris, entring two keywords 1211 (e.g., consecutive impacts 1, 2, 3, 4) and 122 (e.g., consecutive inpacts 1, 2, 3) on the keyboard 106003 as shown, respectively, in FIGS. 6A and 6B, the system may propose a search result including at least the following titles:
Riverin Cite
Andre Antoine Rue
Roses Villa des
Rodenbach Allee des
Eiders Allee des

etc. Note that in this example, only the title Riverin Cite fully complies with the main information and the additional (e.g., vertical relationship of consecutive imacts) information, therefore said title is presented on the top of the list.

Note that, optionally, no total vertical values threshold is required by the search system of the invention using word completion systems by considering the beginning chars of one or more words within a title (e.g., titles) for selecting corresponsing word/presenting a corresponding search result (e.g., a list/plurality of corresponding titles).

According to one aspect, when (e.g., at least a beginnign portion of) a considered keyword fully complies with, preferably one of, optionally all all of, a combined inofrmation, said keyword may be given a bonus value which will be added to the final priority value of a corresponding title. Note that in the this example, the order of the keywords corresponds to the order of the words within a title.

Note that, in regard to a word completion system as described herein, according to one aspect, the search system may be adapted to relate (e.g., a considered portion of) a keyword to any portion of a word of the title (e.g., not limited to the beginning portion of a word only).

Note that vertical (e.g., and/or horizontal) relationship between the consecutive letters and/or interaction impacts may-be/are provided regardless of the distance of the impacts from the corresponding letters (e.g., in a corresponding word) on the/a keyboard.

According to one embodiment, the digits (e.g., 0 to 9) are (e.g., also) presented alphabetically (e.g., «zero» to «six») in a database used by the search system (e.g., of the invention). For example, the number «124» (e.g., as a title and/or within a title) may (e.g., also) be presented by consecutive words separate words «one»«two»«four». This can highly improve the accuracy of prediction of a title by the search system. Optionally, the/a same number may be presented as a single word (e.g., «onetwofour»).

Note that interction with the keys may not be limited to the tapping actions on the keys. Other methods of interacton with the keys may be considered and used. As an example, instead of tapping (e.g., touching) actions on the keyboard, swiping actions (e.g., known in the industry and by many people », etc. with the keyword may be used for providing ketwords.

According to a first aspect, when a user enters a keyword (e.g., herein may be referred to as a «second keyword») of two consecutive keywords, a vertical value of a first interaction impact with the keyboard may be defined/calculated regardless of the vertical location of the last impact of the last/previous/preceding keyword (e.g., herein may be related to a «first keyword») of the said two consecutive keywords(e.g., if any) provided on the keyboard.

According to a second aspect, when a user enters a/the second keyword, a vertical value of a first interaction impact with the keyboard may be defined/calculated in regard to the vertical location of the last/first impact of the previous/first keyword (e.g., if any) on the keybaord.

Preferably, a vertical value of a first character of a word related to the second keyword, is defined by the last interaction impact on the keyboard coresponding to the first keyword.

Note that a delimiter such as space character provided after a keyword defines the end of the keyword. As an example, by considering the keyword of 2F, if a user provides the taps 1 and 2, then provides a space character, and provides the tap 3, and 4, the system considers the vertical values of the first keyword may be as below:
The vertical value assigned to tap 1 is: B
The vertical value assigned to tap 1 is: A;

As such, the vertical value assigned to the tap 3 which corresponds to a first tap related the following keyword will be A as well because the vertical location of the tap impact 3 is within the vertical threshold value in relation to the tap impact 2. The vertical value assigned to the tap 4 which corresponds to a first tap related the following keyword will be «A» as well because the vertical location of the tap impact 4 is higher than the tap impact 3.

According to one aspect, the vertical value assigned (e.g., in real time) to a first character of a word (e.g., «go») corresponding to the secons keyword may be considered to be «A», and the following characters of the word will assigned according to the principles described herein in this patent application. rows of the keyboard so that to augment the accuracy of the search system using consecutive vertical impacts method and using a database of titles including titles that have words including digits/numbers. In FIGS. 2D to 2F, show different keyboard having different exemplary distribution of digits and special characters on the rows of the keyboards. It is understood that other examles of distribution of digits on a keyboard may be considered by people skilled in the art based on the principles described in this patent application.

Note that according to one embodiment, a word of a title is selected/presented if the previous word in the title is a desired word of the title. As such, the search system preferably considers the previous word and/or tapping actions provided for a previous word of the title for such purpose.

The principles of a search result enhancements may be combined with/include one or more search result enhancements/presentation methods/principles (e.g., additional information) and/or embodiments described herein (e.g., herein may be referred to as “combined enhancement methods”). As an example, a search result enhancement based on an impact relationships principles may be combined/considered with at least one of, an error distance calculation method, an of the exemplary presentation methods (e.g., such as any of principles (a) to (h)) as described before, and other methods of selected titles presentation (e.g., such as those described herein) for presenting a number of selected titles/a search result. According to one embodiment, as an example, to each selected title, a value (e.g., herein may be referred to as “final priority value”) by considering based on the main information corresponding to a (e.g., one or more) word/s of the title corresponding to a (e.g., one or more) additional information (e.g., a corresponding total error distance value of the corresponding word/s of said title and/or a corresponding total vertical relationship value of said title may be assigned. As an example the following formula may be applied to each selected title:
Final priority value=(total error distance value of the title)/total number of characters of the title)* (accuracy percentage))

It is understood that other formulas may be considered by people skilled in the art based on principles described herein.

Accordingly, the selected titles may be presented to a user based on the/an (e.g., descending) order of their final priority values.

### (e.g., Final) Priority Threshold Value

Optionally, a search result may include/present all of the selected titles (e.g., preferably in descending order of the priority values). Preferably, a search result may include/present only the selected titles (e.g., preferably in descending order of the total priority values) that the (e.g., final) priority value of each of the them is above a predefined threshold value. The threshold value may vary depending on different parameters such as:
depending on the number of characters of a title.
depending on the number of selected titles.
Etc.

As an example, depending on the number of selected titles, the system may consider a (e.g. predefined and/or based on a dynamically/on-the-fly calculattion) a corresponding priority threshold value.

The examples of methods described above are brought to describe the principles of presenting selected words in accordance to the current invention. Other methods of presentation of selected word, based on principles described herein, may be considered by people skilled in the art.

Note that, a giving priority by the system to a (e.g., selected) title, may preferably mean that said (e.g., selected) title is presented to a user (e.g., displayed on the screen) before/above other (e.g., selected) titles.

Note that the methods of order of presenting selected titles to a user (e.g., on the screen) may be applied to a predefined number of the selected titles.

According to one aspect, predicted titles that have a relatively equal number of matched characters, may preferably be given priority (e.g., shown/presented/sorted) based on the descending order of their longest matched word (e.g., the matched word that has the highest number of characters in the corresponding title). As an example, in this case, a predicted title that has a matched word of ten characters is given priority over another matched title that its longest words has seven characters.

According to one embodiment, other parameters such as the frequency of use of a content related to a title, an arbitrary priority (e.g. priority value) may (e.g., additionally) be considered for selecting a title and/or the for the order of presentation of selected titles.

The presented titles may preferably be interactable. According to one embodiment, after a title is interacted, a function corresponding/assigned to the interacted title may be executed. As a first example, the interacted title may be the title of an Internet article. In this case, said article may be presented to a user (eg., displayed on the screen of the user's device). As a second example, the interacted title may be a telephone number, wherein upon said interaction said number may be dialed. Other functions may be considered based on the principles of the search system of the invention.

According to one aspect, if a title has two or more words that correspond to a single keyword, then, only one of said words may be considered as being related / matched to said single keyword. In this case, an additional similar keyword may be related to an addition word of said two or more words.

According to one aspect the keyboard of the invention may (e.g., be located of a single pad and) virtually be divided into a left large zone/key and a right large zone/key. According to another aspect, the keyboard of the invention may physically be divided into a left large zone/key and a right large zone/key.

As shown by the exemples provided herein, the search system of the invention, is an accurate breaktrough technology in the field of content search (e.g., based on keywords).

It is important to note that the term “title” and a database of movie titles is/are used as an example for describing the principles of the search application of the invention. As mentioned, the search application described herein may be used for searching any type of textual content/phrase/term (within a corresponding database) such as movie titles, music titles, song titles, scientific terms, medicine titles/terms, titles formed of one or more sequences of symbols, etc.

Note that, each large zone of the keyboard of the invention having two large zones, may include any of a plurality of characters/letters of an alphabet. Said zones may be in horizontal axis (e.g. for Roman alphabet), or in vertical axis (for Japanese language/alphabet)

According to one embodiment, the search system using the data entry system of the invention may be implemented and run within a mobile device such as a smartphone or tablet, etc. Alternatively, a touch pad representing the keys of a keyboard of the invention may be used for the same purpose.

Note that the data entry system of the invention may use any type of keyboard such as a keyboard with virtual (letter) keys or with physical (letter) keys.

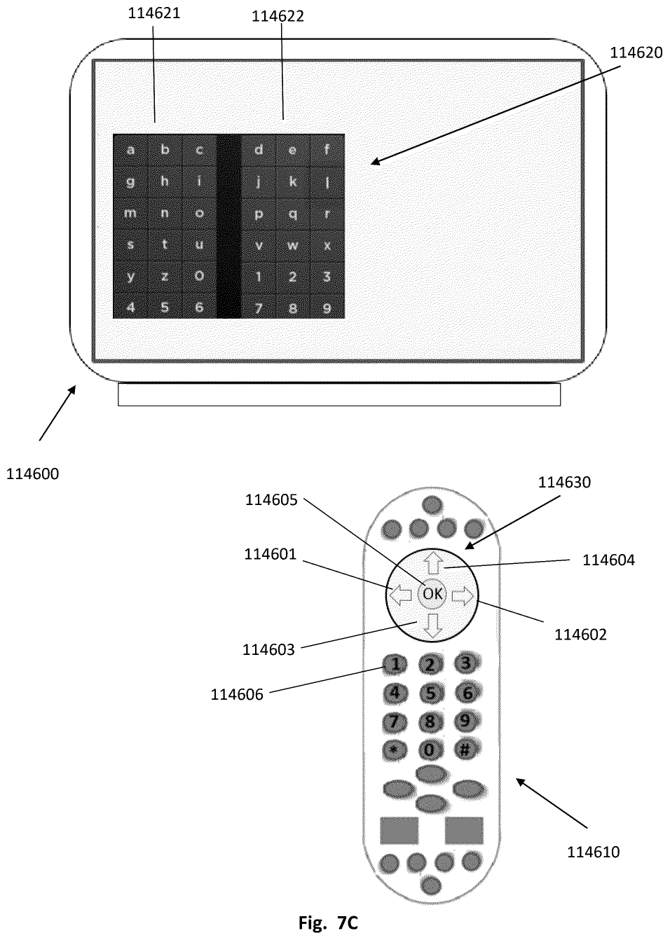

Note that any of the keyboards described herein are used to demonstrate the principles of the inventions described herein. Any other type of keyboard (e.g. soft, hard, etc.) having any number of keys/zones, any size, any key and/or characters configuration, etc. may be used with the inventions. FIG. 7A shows as an example, a smartphone with a keyboard 107000 having a QWERTY letter-key configuration in which the letters, digits and special characters are divided into two groups each assigned to a different large zones/keys, a left (large) zone 107001 and a right (large) zone 107002. Said keyboard may be used for searching titles by the search and data entry systems of the invention for predicting titles based on principles described in this patent application.

According to one embodiment, a title database may include/be-comprised-of numbers (e.g., sequence of digits 0 to 9) such as telephone numbers (e.g., of contacts list of a corrsponding user's smartphone. Accordingly, a corresponding keyboard of the invention may include digits as well and special chracters as well. In the exemplary keyboard of FIG. 7A, digits 0 to 4 are represented/assigned-to the left large key 107201, and digits 5 to 9 are represented/assigned-to the right large key 107202. An interaction with a large key of the keybaord may ambiguously correspond to a/any of the characters assigned to a large key/zone. As such, as an example, a user may type telephone numbers without looking at the corresponding input interface (device). This may be very usuful in some situations such as while driving. Because a user's phone contacts database may have at most a few hundreds of contacts, the chances are very high that the search system of the invention select only one (e.g., or a maximum of a few) corresponding telephone number for a keyword entered by a user. As an example, the keyword «12121211112» may be related by the system to the telephone number 15162724419 within a database of titles used by the system.

FIG. 7B, shows a keyboard of the search information of the invention having two physical keys/pads 107101 and 107102 corresponding to, respectively, the left zone and the right zone of the keyboard of the invention, implemented within steering wheel of a car. A user can type keywords for searching desired contents using the two keys without the need of focusing on said two keys. Preferably, the keys/pads are touch sensitive so that additional information (e.g., such as error distance value, consecutive letters vertical relationship), swiping gestures corresponding to different functions/characters (e.g., such as those described in this patent application), etc., may be provided/calculated on/using said keys/pads. Note that such keys/pads may be implemented within any other device. Preferably, interacting with any portion of a first key (e.g., 107101) of said two keys may provide same first input information (e.g., “1”) (e.g., of the main input information), and interacting with any portion of a second key (e.g., 107102) of said two keys may provide same second input information (e.g., “2”) (e.g., of the main input information). Additionally, interacting with the top (e.g., upper half) portion of any of the first and the second keys may provide the vertical value “A” (e.g., of the additional input information), and interacting with the button (lower half) portion of any of the first and the second keys may provide the vertical value “B” (e.g., of the additional input information). Note that, when usinf the vertical relationship (e.g., only) method of the invention, the width of a large key can be reduced significantly (e.g., to less than 2 centimeters or as narrow as the size of a fingertip of a user, etc.).

The technology described above is can be used for transmitting title (e.g., phrases, messages, etc.) from a first device to another/other (e.g., one or more) (e.g., remoe) device/s wihout transmitting the title itself. According to one embodiment, a search application of the invention running on a first device is adapted to execute a search procedure such that (e.g., after a title is selected by a user entering a main and an additional information) instead of sending the selected title, the first (e.g., corresponding) device may transmit/send the combined information and preferably a reference to the selected title (e.g., the location of the title in the result list) to a (e.g., remote) second device. Thereafter, the combined information received by the second device may be used by a preferably similar seach system/application running on the second device to reproduce the/a preferably similar search result and preferably said reference may be used to define/point-to the corresponding selected title (e.g., by the user of the first device) on the second device. Note that, accordingly, the search system in the second device, preferably, uses a similar title database.

It must be noted that the the additional information regarding consecutive vertical and/or horizontal location relationship of (e.g., each of) the impacts (e.g., regarding to a word/keyword of a title) as described herein is calculated regardless of the distance of an interaction impact, provided on (e.g., a large zone/key on) a keyboard, from a (e.g., desired) letter on the keyboard. This means that the consecutive impacts may be provided anywhere/sloppily on the (e.g., corresponding zones of the) keyboard as long as said impacts (e.g., (e.g., at least) substantially/preferably, completely) respect the principles (e.g., of the location relationships) described herein.

The arrangement of letters on few (e.g. two) large keys/zones may be applied to some of the keys of a remote control (e.g. TV remote control, etc.). Preferably the letter keys are used with a text predictive systems for entering text as described herein. Additional characters such as special characters and some functions may be assigned to the remaining buttons of the number keys or other numbers of the remote control.

As mentioned before, the input interface/keyboard may have an alphabetical layout. FIG. 7C shows an exemplary keyboard having alphabetical letter layout (e.g., order/arrangement) for use with the search system of the invention. In the example of FIG. 7C, alphabetical letters (e.g., of a keyboard) are divided in two groups 114621 and 114622 and displayed on the screen of a TV 114600. In this example, a TV remote control device 114610 having a (e.g., traditional) 4-direction key 114630 (e.g., in other words, consisting of 4 sub-keys 114601-114604 and an additional sub-key 114605 in the/its center) is used with the search system of the invention. In this example, the first group of letters 114621 is assigned to the left sub-key 114601 and the second group of letters 114622 is assigned to the right sub-key 114602. The group of letters 114621 and 114622 are displayed on the screen of a corresponding TV 114600. Further, the/a space character is assigned to the sub-key 114603 and the/a backspace function is assigned to the sub-key 114604. In this example, pressing the key 114605 preferably executes a search procedure of the invention in accordance/based on a sequence of one or more keywords being entered. Further, pressing the exemplary key 114606 preferably executes a process for deleting a (e.g., the current) search procedure.

According to one method, the space key me be assigned to (e.g., at least) one of said large keys and be presented by the digit corresponding to said large key. In ths case, the digitized words of the titles are orginized such that to include the digit representing the space key.

The search sysem of the invention, enables the users (e.g., on the move, in a meeing, etc.) to search for and find his/her desired textual content (e.g., title) within a database without the need of looking at the keyboard by using only two (e.g., large) keys. As an exam a user may find and play a song while jogging.

According to one aspect, a text to speech may be used by the search system of the invention for speaking the correspondig list of titles to the user (e.g., for selecting a desired song).

Also as an example, the searching system may be used by a policeman for searching a content within a regsitery of contents while driving. And etc.

According to one embodiment, in addition to and/or in replacement of letter key, the keyboard of the invention, the words and/or digitized words of a database used by the system may include/comprise other characters such as digits and special characters.

The search system of the invention may be used by/in any language hving any type of characters/letters such as alphabetical languages, ideogrammic (e.g., japanese) languages etc.

According to one aspect, the database uses by the system may include the digitized words. According to another aspect, a digitized word of the database is dynamically created during a search procedure.

It must be noted that although only two broadly ambiguous keys are used to show the principles of the search system of the invention, any other number of ambiguos keys may be used by the search system of the invention based on priciles described herein.

The principles just described may be applied independently or in combination with other principles defining the degree of ambiguity as described in this application for predicting words.

The principles described may also be applied to swiping principles to type words as described herein. As an example, fast swiping actions may be related to fully ambiguous/predictive mode and slow swiping actions may be related to semi-ambiguous (e.g. semi predictive) mode.

According to one aspect, by using a keyboard of the invention having large zones, the speed of typing may be measured in each zone independently and/or regardless of the zones.

According to one aspect, measuring the speed of typing and relating it to slow and/or fast and predicting words typing may be applied to any type of keyboard such as traditional keyboard (e.g. QWERTY).

Note that in the embodiments described above, a correcting system may be used with the system so that to relate an impact to any of the characters of the keyboard by relating it to a mistyping action.

Note that all of the principles of the data entry system described herein are used by the data entry system of the invention to predict/present words (e.g. to a user) upon receiving a sequence of interaction with the/a keyboard (e.g. of the invention) by a user for entering a word.

Note that, interaction with keys/zones of a keyboard of the invention may be f any kind. As an example, instead using tapping actions swiping actions or a combination tapping and swiping actions may be used for the same purpose. As an example, providing a swiping action from a left large zone/key to a right large zone/key may be considered as tapping on the left and the right zone/key.

The assignment of a group of characters to a large zone may vary. As an example, (e.g., a first row of) a left large zone may include the letters QWERT and (e.g., a first row of) a right large zone may include the letters YUIOP. Also as an example, (e.g., a second row of) a left large zone may include the letters ASDFG and (e.g., a second row of) a right large zone may include the letters HJKL. Etc.

According to one embodiment, the input interface of the invention may be a toch sensitive surface wherein no large keys are preciselydefined. In this case, an interaction with a large zone is dynamically defined based on a location of a user's interaction impact on said interface. As an example, if a user taps on a left side of the input interface, said interaction is preferably be related to an interaction with a left large zone. Accordingly, if the user taps on a right side of the input interface, said interaction is preferably be related to an interaction with a corresponding right large zone.

According to one aspect of the invention, selected titles may be presented to a user during the entry of word (e.g., before entering before an end-of-the-word signal).

According to one embodiment, the titles (e.g., herein may be referred to as “entries”) of a database of titles used by the search system of the invention may be related to different types of contents. This type of database of titles may herein be referred to as “mixed database”.

According to one embodiment of the invention, a search system/application may be created for executing a different type of function based on selection of a different (e.g., corresponding) title by a user. As an example, a first entry (e.g., a title) of the mixed database may be related to a song, a second entry (e.g., a title) of the mixed database may be related to a video, a third entry (e.g., a title) of the mixed database may be related to a text document, a forth entry (e.g., a title) of the mixed database may be related to a contact of the Contacts database of a user, a fifth entry (e.g., a title) of the mixed database may be related to an image, etc.

According to a first scenario, after a title is selected by a user from a list of potential/predicted candidates, a number of different choices of functions may be presented to the user. Said choices may be in form of different icons. Upon selecting a choice (e.g., an icon), the system may execute the corresponding function. As an example, one of, a first, second, third, fourth, fifth, sixth, seventh, etc, selected choice/icon may be related to performing/executing (e.g., by the/a system) a (e.g., different) function such as, respectively, playing (e.g., streaming) a movie, playing a song, opening a URL (e.g., related to a webpage), playing a song, opening a (e.g., text) document, presenting/displaying a photo, presenting/displaying a contact information of a user within the Contacts folder of the user's device, etc., based-on/relating-to the selected title.

According to a second scenario, the system/application may first present said choices, then, upon selecting of one of said choices by the user the system may present the search interface of the interface so that the user proceed to a search session through the search system of the invention for selecting a desired title. Thereafter, after selecting a title among a number of one or more title candidates predicted/presented by the search system, the/corresponding system may preferably perform a/the function corresponding to the selected choice and the selected title.

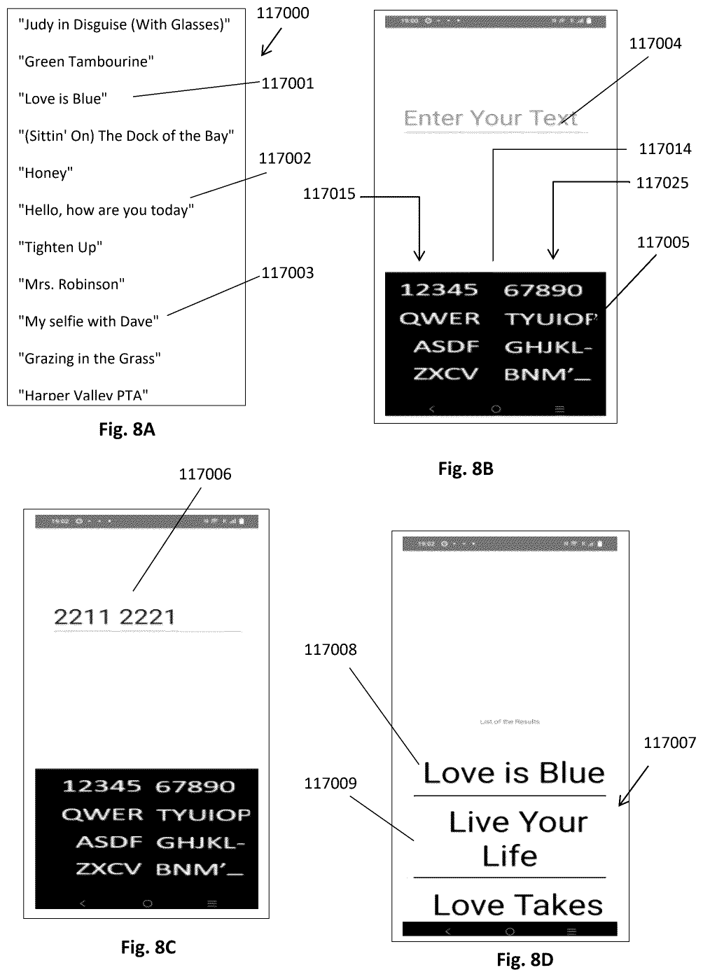

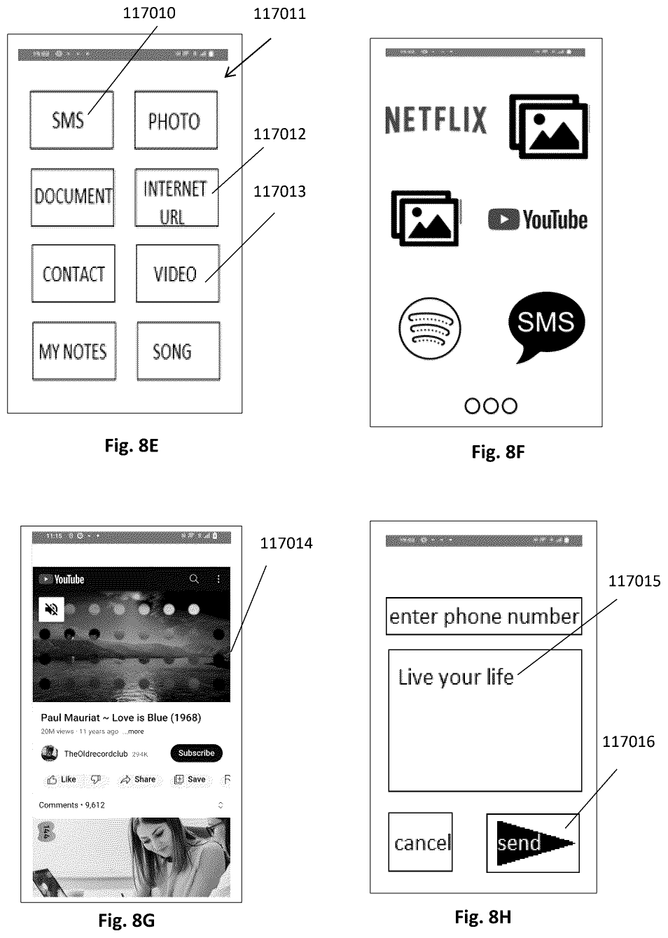

FIGS. 8A to 8H describe an example of different processes of a search system/application of the invention according to principles described above. FIG. 8A shows an exemplary portion 117000 of an exemplary database of titles of the invention which includes different titles relating different type of functions/contents. As an example, title 117001 is related to a song/video, title 117002 is related to a predefined (e.g., SMS) message, and title 117003 is related to an image (e.g., a photo).

FIG. 8B shows a search interface of the invention having a keyboard 117005 of the invention and a text input field 117004 related-to used-by the keyboard 117005. As described before, according to one aspect, pressing/tapping-on the left portion/zone 117015 of the keyboard may preferably provide a first input signal (e.g., the character/value “1”) and pressing/tapping-on the right portion/zone 117025 of the keyboard may preferably provide a second input signal (e.g., the character/value “2”). In tis example a gap 117014 separates the first and second portions/zones of the keyboard.

In FIG. 8C, as an example, a user searching for the song/title “Love is Blue” 117001, has entered two sequences of key presses/values 117006 (e.g., two keywords, “2211” and “2221”), corresponding to the words “Love” and “Blue”. As shown in FIG. 8D, based on entering said two keywords, the system has provided a list of scrollable corresponding predicted titles that a portion 117007 of the list is shown on the screen of a corresponding device. In this example, providing said two keywords have been enough for the system to present/show the desired title 117008 as the first choice to the user. According to one aspect, different scenarios may be considered such as:
a) According to a first scenario, if the user selects the desired title 117008 (e.g., by tapping on it), the system may either play a corresponding music by the search system itself (e.g., if the search system has its own music/video player and the corresponding song in its own database available) or indirectly through (e.g., by using (e.g., an API of)) a third party music playing application (e.g., Spotify, YouTube, etc., etc.).
b) According to a second scenario, upon selecting a title by the user, the system shows/presents (e.g., an interface including) a number choices/functions for executing a function related to the selected title. In the exemplary FIG. 8E, the system has presented a number of icons each representing a function (e.g., application). After selecting an icon/application, the search system itself, or optionally a corresponding application, executes a function corresponding to the selected title. As an example, as shown in exemplary FIG. 8G, if the user selects the title 117008 and selects (e.g., taps on) the video icon 117013, a video 117014 corresponding to the selected title is played (e.g., on the screen). Note that, in this example, the system may use a YouTube API (e.g., that searches for the video corresponding to the selected title in its/a-corresponding content/video database) for playing the corresponding video.

With continuous description of the current embodiment, as another example, as shown in exemplary FIG. 8H, if the user selects the title 117009 and selects (e.g., taps on) the SMS icon 117010, a SMS interface is preferably presented (e.g., on the screen) permitting the user to send said title as a SMS message by entering a desired phone number and pressing the send key 117016. Note that, in this example, the system uses a SMS system of the device for sending the message.

Note that according to a first aspect, the search system may have its own database and software for (e.g., presenting (e.g. such as the example of FIG. 8E) and) executing a function related to a selected title, wherein according to a second aspect, the search system may use a third party software/application and database for executing a function related to a selected title. In this case, according to one method, as shown in FIG. 8F, the search system (e.g., or a related system) may present an interface representing a number of related third party applications (e.g., represented by their own icons) to the user so that the user selects a desired application. Thereafter, according to a preferred aspect, the system preferably uses an API of the selected application so that said application executes a function corresponding to the title selected by the user.

According to an aspect of the invention, (e.g., in a same predicted list of titles) a function related to a first selected title may be executed by the search system/application itself, while a function related to a second title may be executed by another application running independently from the search application.

According to one embodiment, each title within a database of titles may have a corresponding/related function. According to one aspect, functions related to titles within a database of titles may be stored within said database or they may be stored within a separate database. Different type of functions related to titles/entries within a database of titles may be stored in different form of data. As an example, a data corresponding to a movie may be stored in form of a corresponding URL, a data corresponding to contact within the Contacts database of a corresponding user's device may be stored in form of a reference to the Contacts folder of the device, etc.

A related data of a first title may be in form of a URL. Note that, a (e.g., one or more) database of titles and/or the/a related (e.g., database of) functions used by the search system of the invention may be stored within a user's device and/or within a remote server (e.g., in a cloud (e.g., server)).

Note that a search session of the invention may be executed by using more than one (e.g., type of) information provided by a user. As an example, a search session for selecting and playing a movie may be executed based information corresponding to at least a portion of the name/title of a movie entered by a user as described herein. According to another example, a search session for selecting and playing a movie may be executed based on information corresponding to at least a portion of the title of the movie and the a name of one or more actors of the movie entered by a user.

According to one method, a single (e.g., text) input field may be used for entering multiple types of information corresponding to a title (e.g., movie). According to another method, multiple (e.g., text) input fields may be used for entering multiple types of information corresponding to title (e.g., movie). As an example, a first type of information (e.g., corresponding to a movie title) may be entered through a first input field, and a second type of information (e. g, corresponding to the names of the movie actors) may be entered through a second input field.

### Simplified Interface

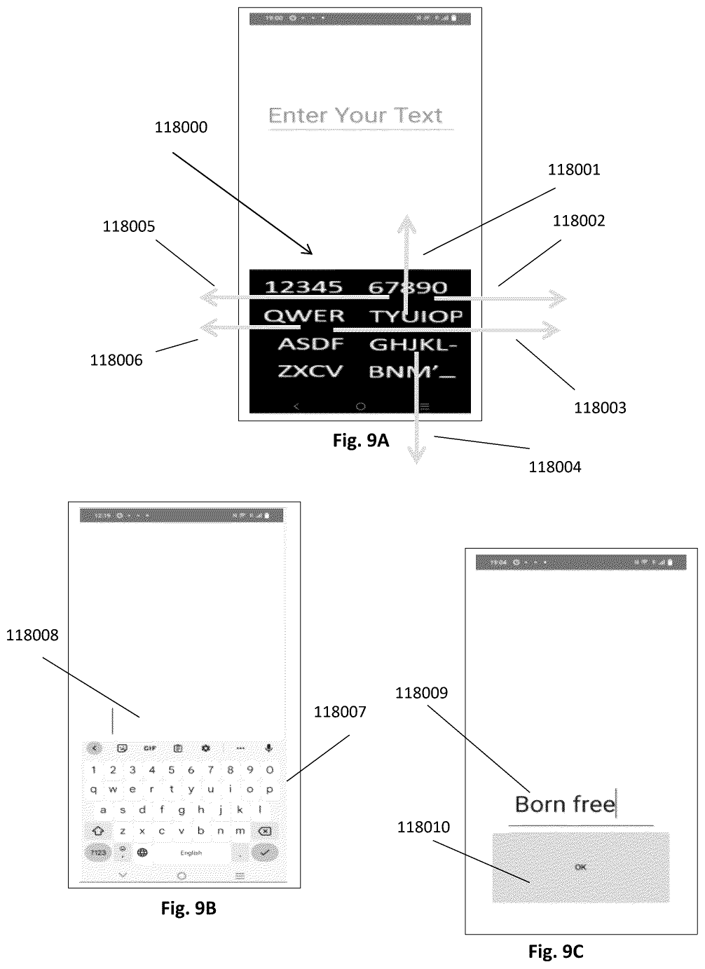

The search system of the invention is created in view of providing an easy to use sophisticated search procedure. As such, preferably, the overall interface of the system must preferably also be user-friendly, especially in mobile environment. FIG. 9A shows an exemplary simplified interface of the search system of the invention in which a keyboard 118000 of the invention is presented. In this exemplary interface some (e.g., necessary) buttons are replaced by swiping gestures (e.g. herein may be referred to as “gestures”). As an example:
providing a rightwards gesture 118002 or 118003 from anywhere on the keyboard may preferably provide a space character.
providing a leftwards gesture 118005 from right side/zone on the keyboard may preferably provide a backspace function.
providing a leftwards gesture 118006 from left side/zone on the keyboard may preferably delete the last word (e.g., or the word before/preceding a cursor in the text input field) or optionally the entire text in the text input field.
providing a downwards gesture 118004 from right side/zone on the keyboard may preferably execute a search session corresponding to the keywords entered in the text field.

According to one aspect of the invention, a user is preferably enabled to add his/her own titles within a database used by the search system of the invention. As an example, providing an upwards gesture 118001 from (e.g., right side/zone) on the keyboard may preferably cause the system to present, an interface, as shown in the exemplary interface of FIG. 9B, for adding user's desired titles to the database used by the search system. In this example, preferably a text input field 118008 and a standard keyboard (e.g., the original keyboard of the user's device) 118007 are available so that to permit the user to enter his/her desired text 118009, as shown in FIG. 9C. In this example, after removing the keyboard by the user and pressing the OK button 118010, the title 118009 is preferably added to a corresponding database of titles used by the search system of the invention.

As described throughout this patent application, the search system of the invention preferably mat preferably use a keyboard divided into two large zones/keys. According to one embodiment, based on this principle, a system for entering keywords easily and quickly may be created.

When a user starts to type a keyword, he/she may first preferably provide a first tapping action on a large zone/key corresponding to the first character of the desired word. Each of following tapping actions is preferably provided based on the/its precedent tapping action and/or precedent tapping impact (e.g., on the keyboard). As an example:
a) if the precedent tapping action is related by the system to interacting with the left large zone/key of the keyboard (e.g., resulting in providing a first predefined input signal (e.g., character “1”) by the system), then, providing a (e.g., the following) tapping action anywhere on the right side of the precedent interaction impact (e.g., on the keyboard) will preferably be related by the system to interacting with the right large zone/key of the keyboard (e.g., providing a second predefined input signal (e.g., character “2”) by the system).
b) if the precedent tapping action is related by the system to interacting with the left large zone/key of the keyboard (e.g., providing a first predefined input signal (e.g., character “1”)), then, providing a (e.g., the following) tapping action anywhere on the left side of the precedent interaction impact (e.g., on the keyboard) will preferably be related by the system to interacting with the left large zone/key of the keyboard (e.g., providing the/a (e.g., same) first predefined input signal (e.g., character “1”)).
c) if the precedent tapping action is related by the system to interacting with the right large zone/key of the keyboard (e.g., providing said second predefined input signal (e.g., character “2”)), then, providing a (e.g., the following) tapping action anywhere on the left side of the precedent impact (e.g., on the keyboard) will preferably be related by the system to interacting with the left large zone/key of the keyboard (e.g., providing a/the first predefined input signal (e.g., character “1”)).
d) if the precedent tapping action is related by the system to interacting with the right large zone/key of the keyboard (e.g., providing a/the second predefined input signal (e.g., character “2”)), then, providing a (e.g., the following) tapping action anywhere on the right side of the precedent impact (e.g., on the keyboard) will preferably be related by the system to interacting with the right large zone/key of the keyboard (e.g., providing a/the second predefined input signal (e.g., character “2”)).

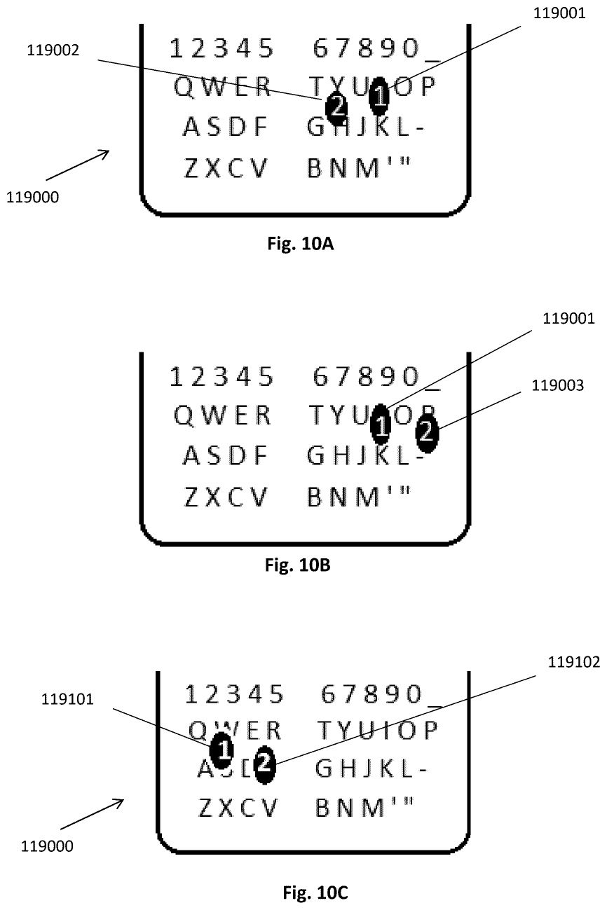

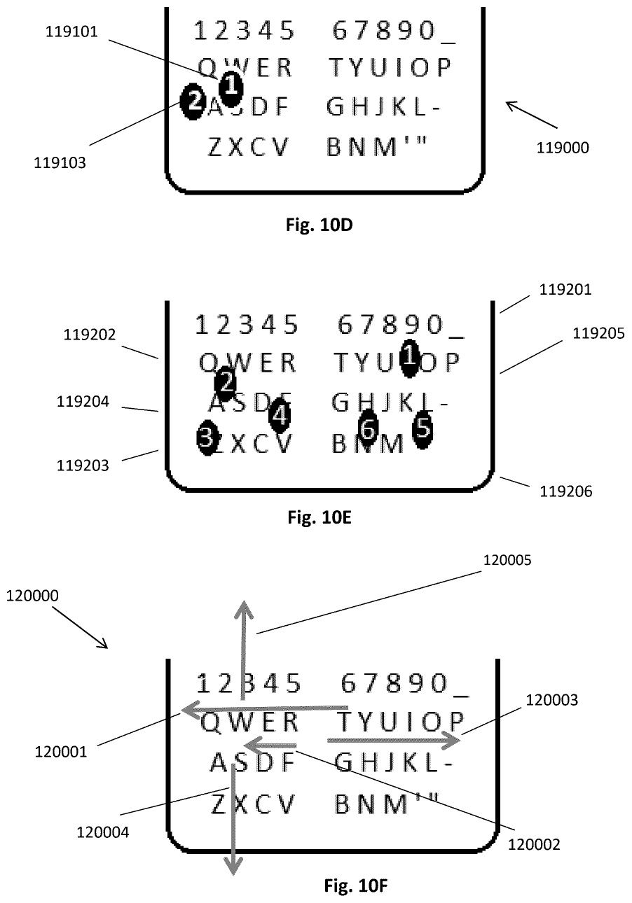

With continuous description of the current embodiment, FIGS. 10A to 10E show some examples of the principles described above. FIG. 10A, shows a keyboard 119000 divided into two large zones 1191001 and 1191002. In this example, the user has provided a first tapping action (e.g. shown by the impact “1”) 119001, corresponding to the first character of a desired word, on the right large zone of the keyboard 119000. In this case, the system relates said tapping action to a/the corresponding second input signal (e.g., character “2”) assigned to an interaction with the large right zone of the keyboard. The user then has provided a second/following tapping action (e.g. shown by the impact “2”) 119002 on a left location/side relative to the first impact 119001 on the keyboard. In this case, the system preferably relates said second/following tapping action to interacting with the left large zone of the keyboard (e.g., even though the tapping action is provided on the right large zone/key) and provides a/the first input signal (e.g., digit “1”) assigned to interacting with the left large zone of the keyboard (e.g., said/the two interactions, together, providing/forming the keyword “21”). In the current example/embodiment, as shown in FIG. 10B, after providing the first tapping action 119001, (e.g., instead of providing the second/following interaction on the left side of the first/precedent impact) if the user provides a/the second/following tapping action 119003 (e.g., anywhere) on a right location/side (e.g. shown by the impact “2”) relative to the first impact 119001 on the keyboard, the system preferably relates said second/following tapping action to interacting with the right large zone of the keyboard and provides a/the second input signal (e.g., digit “2”) assigned to interacting with the right large zone of the keyboard (e.g., said/the two interactions, together, providing/forming the keyword “22”).

In FIG. 10C, the user has provided a first tapping action (e.g. shown by the impact “1”) 119101, corresponding to the first character of a desired word, on the left large zone of the keyboard. In this case, the system relates said tapping action to a/the corresponding first input signal (e.g., character “1”) assigned to an interaction with the left large zone of the keyboard. The user then has provided a second/following tapping action (e.g. shown by the impact “2”) 119102 on a right location/side relative to the first impact 119101 on the keyboard. In this case, the system preferably relates said second/following tapping action to interacting with the right large zone of the keyboard (e.g., even though the tapping action is provided on the left large zone/key), and provides a/the corresponding second input signal (e.g., digit “2”) assigned to interacting with the right large zone of the keyboard (e.g., said two interactions together providing/forming the keyword “12”). In the current example/embodiment, as shown in FIG. 10D, after providing the first tapping action 119101, (e.g., instead of providing the second/following interaction on the right side of the first/precedent impact), if the user provides the second/following tapping action 119103 (e.g., anywhere) on a left location/side (e.g. shown by the impact “2”) relative to the first impact 119101 on the keyboard, the system preferably relates said second/following tapping action 119103 to interacting with the left large one of the keyboard and provides a/the corresponding first input signal (e.g., digit “1”) assigned to interacting with the left large zone of the keyboard (e.g., said/the two interactions together providing/forming the keyword “11”.

In exemplary FIG. 10E, the user has provided a sequence of interaction (e.g., six tapping actions) with the keyboard. The user has provided:
a) a first tapping action (e.g. shown by the impact “1”) 119201, corresponding to the first character of a desired word, on the right large zone of the keyboard. In this case, the system relates said tapping action to a/the corresponding second input signal (e.g., character “2”) assigned to an interaction with the large right large zone of the keyboard.
b) The second tapping action (e.g. shown by the impact “2”) 119202 is provided on the left side of the precedent tapping action 119201. In this case, as mentioned before, the system preferably relates said second tapping action to interacting with the left large zone of the keyboard and provides a/the first input signal (e.g., character “1”) assigned to interacting with the left large zone of the keyboard.
c) The third tapping action (e.g. shown by the impact “3”) 119203 is provided on the left side of the precedent tapping action 119202. In this case, as mentioned before, the system preferably relates said third tapping action to interacting with the left large zone of the keyboard and provides a/the first input signal (e.g., character “1”) assigned to interacting with the left large zone of the keyboard.
d) The fourth tapping action (e.g. shown by the impact “4”) 119204 is provided on the right side of the precedent tapping action 119203. In this case, as mentioned before, the system preferably relates said fourth tapping action to interacting with the right large zone of the keyboard and provides a/the second input signal (e.g., character “2”) assigned to interacting with the right large zone of the keyboard.
e) The fifth tapping action (e.g. shown by the impact “5”) 119205 is provided on the right side of the precedent tapping action 119204. In this case, as mentioned before, the system preferably relates said fifth tapping action to interacting with the right large zone of the keyboard and provides a/the second input signal (e.g., character “2”) assigned to interacting with the right large zone of the keyboard.
f) The sixth tapping action (e.g. shown by the impact “6”) 119206 is provided on the left side of the precedent tapping action 119205. In this case, as mentioned before, the system preferably relates said sixth tapping action to interacting with the left large zone of the keyboard and provides a/the first input signal (e.g., character “1”) assigned to interacting with the left large zone of the keyboard.

In the current example, the sequence of interactions, together, produce/form the keyword “211221”.

It must be noted that in examples of embodiments throughout this patent application, characters “1” and “2” used to represent the first and second input signal are used for describing those embodiments in a simple manner. In fact, other means/form of data (e.g., bits “0” and “1”) may be used for the same purpose.

Preferably, each time that a user finishes to type a keyword (e.g., by providing an end-of-a-word-signal such as providing a space character, an “Enter” function, etc.), the precedent tapping action is not considered by the system and preferably for the first character of the new keyword, the user is required to type on a corresponding large key. Note that according to one aspect, a predefined special character may be defined to be as an end-of-a-word signal.

Preferably, during providing a sequence interactions with the keyboard for the entry of a keyword, if the user provides a function of (e.g., of a/the keyboard) (e.g. a backspace function) that is not related to entering an input signal corresponding to a following character of a desired word or if more than a predefined laps of time has passed between two consecutive tapping actions corresponding to consecutive characters of a desired word, etc., the precedent tapping action is not considered by the system and for a tapping action related to the next character of the word, the user is preferably required to type on a corresponding large key.

Swiping gestures provided from any location on the keyboard towards/in different directions may be used for providing different functions/characters/symbols. As an example, FIG. 10F shows exemplary swiping gestures for providing a number of functions that may become necessary for/during the entry of a keyword. As an example, a long swiping action (e.g. 120001 with a length of at least half of the width of the keyboard) in a first direction (e.g., towards left) preferably departing from anywhere on the keyboard may corresponding to deleting at least the last keyword (e.g. before the cursor within a corresponding text). A short swiping action (e.g. 120002 with a length of a fourth of the width of the keyboard) in a predefined direction (e.g., towards left) preferably departing from anywhere on the keyboard may corresponding to deleting the last character of a keyword (e.g. before the cursor within a corresponding text). A swiping gesture (e.g. 120003) in a second direction (e.g., towards right) preferably departing from anywhere on the keyboard may corresponding to entering a space character. A swiping gesture (e.g. 120004) in a third direction (e.g., downwards) preferably departing from anywhere on the keyboard may corresponding to entering into a search procedure based on the entered one or more keywords. A swiping gesture (e.g. 120005) in a fourth direction (e.g., upwards) preferably departing from anywhere on the keyboard may correspond to entering into a procedure of adding user's desired/custom titles to a/the titles database used by the system.

According to one embodment, the first tapping action, of a sequence of tapping actions related to entering a keyword, may be provided anywhere on the keyboard/screen. In this case, if the related character (e.g., «1» or «2») provided/proposed by the system is not the desired character, the user may delete the proposed character. Thereafter, the user may provide the next tapping action on a correct/desired location relaive to the location of the precedent/deleted tapping action.

### Vertical Zones

Note that according to one aspect, the left and/or right large zones described herein, may be designed to be arranged as upper and/or lower large zones (e.g. large zones arranged vertically). FIG. 1C, shows a keyboard 101100 having alphabetical layout/order. The keyboard is divided into two large zone 101101 and 101102 being arranged vertically (e.g., the large zone 101101 is positioned above the large zone 101102.

Thus, while there have been shown and described and pointed out fundamental novel features of the invention as applied to alternative embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto. It is to be understood that the drawings are not necessarily drawn to scale, but that they are merely conceptual in nature.

For example, any other kind of keyboard having any number of large keys/zones, any kind of key/zone configuration, any type of keys/large-zones (e.g. physical/hard keys, touch sensitive keys such as on-screen keys, combination of hard and touch sensitive keys, physical keys with touch sensitive surface, keys/zones dynamically (e.g. during interacting with a touch screen) defined, virtual keys interacted (from far) in the air, any size of keyboard, with any kind of configurations of symbols assigned to its keys, etc., may be used with the inventions, principles, aspects, embodiments, methods, etc., described herein.

Note that according to a general aspect, interacting with different keys/zone of any keyboard or any other input means of an input interface may provide corresponding different input signals. To each of at least some of said input signals a number of letters/characters of a language may ambiguously be assigned. By receiving a sequence of one or more such input signals the text predictive system of the invention may predict a word as described throughout this patent application.

Note that the keyboards, data entry and search systems described in this patent application may be used with and/or integrated within any type of device with any size of the screen such as a Smartwatch, a Smartphone, a tablet, a large screen of or related to a (e.g. wearable) computing device, etc.

Note that all of the principles of the (e.g. text predictive) data entry system of the invention may be used with any of type of keyboard such as those of the current invention.

For not frequently repeating the principles of the data entry system of the invention, in many paragraphs of this application there is mentioned that one or more symbol such as character/word/portion-of-a-word/function, etc., may be assigned to a key (e.g. or an object other than a key). It is understood that unless otherwise mentioned, said symbols, generally, are intended to be assigned to a predefined simplest interaction with said key which may be a single-pressing action on said key.

Note that although in some embodiments a sensitive surface such as a touch-sensitive pad or a touch screen have been used as examples, it is understood that any other technology detecting and analyzing a user's interaction with an object (e.g. from near or remotely) may be used to define interaction with a keyboard. For example, said technology may be an optically detecting technology, or an (e.g. infra-red) IR technology, etc. detecting the user's finger/s touching a virtual keyboard or interacting with it from far (e.g. in the air).

It must be noted that at least one/some of principle, features, aspects, concepts, etc., described throughout this application may be combined together and used in any portion of the description of the invention herein to enhance the invention.

Note that any electronic device such as a mobile phone, tablet, smartwatch, etc. may be used by any of the inventions, concepts, aspects, principles etc. described within this patent application or with any other application and/or product.

Note that at least one or more of the inventions, concepts, aspects, principles etc. described within this patent application can be used separately or in combination within this patent application or with any other application and/or product.

Note that the keys/zones may be of any kind such as mechanical/hard, virtual/on-screen, pad, touch sensitive surface, etc., or combinations of them.

Note that a vertical value relating to one or more keywords provided for searching for a desired title, preferably means a sequence of vertical values corresponding to the impacts provided for generating said keywords.

Note that any of the keyboards described herein are used to demonstrate the principles of the inventions described herein. Any other type of keyboard (e.g. soft, hard, etc.) having any number of keys/zones, any size, any key and/or characters configuration, etc. may be used with the inventions.

It must also be noted, that any of the systems, features, means, methods, etc., described in this patent application may be used separately or being combined with or replace systems, features, means, methods, etc., of other different embodiments of this patent application. Note that a keyboard may have any number of large zones (e.g. 1, 2, 3, or more).

For example, the keys/zone of the keyboard may be defined dynamically when a user touches a location on the keyboard. In this case at least some of the characters near the user's finger impact on the keyboard define a (e.g. an ambiguous) key/zone. Said zone may preferably be horizontal zones (e.g. the characters in the corresponding horizontal direction are selected).

Note that although the term(s) keys/zones are used to describe providing input information for entering text, any other input means may be used for the same. In general, the system may receive a sequence of at least one input signal ambiguously corresponding to a group of characters and/or precisely corresponding to an identified character from any input means to predict a word.

Note that any of the data entry systems and/or input means described in this application may be applied to and/or integrated with devices with screens of any size such as a smartwatch, a smartphone, a tablet, and devices with larger screens.

Note that all principles, methods, systems, embodiments, features, functions, etc. described in this application are not limited to the examples described herein. They may be used for a broader purpose. Note that according to one aspect the keyboard may include any number of large zones.

It must be noted that in some portions of this application an invention may be described by referring to a specific content and/or function, it is understood that any other content and/or function may be used with any invention described herein.

For the ease of explanation, in some embodiments of this patent application, the word “letter” is used to describe/refer to a character ambiguously assigned to a large key. It is understood that the world “letter” is preferably related to ambiguously relate to any character assigned to said large zone.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

The above explains several embodiments with reference to the drawings. Each embodiment may have a portion corresponding to that of a precedent embodiment. Such a portion is preferably assigned with an identical reference number so as to omit overlapped explanation. When only a portion of the configuration of each embodiment is explained, the other portions of the configuration may adopt those of the precedent embodiment previously explained. Partial combination between the embodiments may be possible with respect to not only a portion which is explicitly described in each embodiment, but also a portion which is not explicitly described.

1. A system for searching a user's desired content within a database of textual contents, comprising:
a database of textual contents, each textual content having one or more words;
a keyboard having a plurality of characters comprising at least the letters of a language, said characters being divided into two groups of characters, wherein each group being assigned to a different zone/key on the keyboard; and
a processor;
wherein upon providing a sequence of interactions with the said zones/keys of the keyboard and by considering the location relationship of the user's consecutive interaction impacts, corresponding to said interactions with said zones/keys, relating to each other the search system using the processor presents one or more corresponding textual contents to the user.

2. The system of claim 1, wherein said location relationship is the vertical relationship of two consecutive impacts relating to each other.

3. The system of claim 1, wherein said location relationship is the horizontal relationship of two consecutive impacts relating to each other.

4. The system of claim 1, wherein said location relationship is the vertical and horizontal relationship of two consecutive impacts relating to each other.

5. The system of claim 1, wherein each of at least one of said textual contents is a titles of another digitized content.

6. The system of claim 5, wherein upon presenting with a presented title, the corresponding content is presented to the user.

7. The system of claim 1, each of at least one of said textual contents is related to another content and wherein upon presenting with a presented a textual content, a corresponding digitized content is presented to the user.
